(19) United States
(12) Patent Application Publication
(10) Pub. No.: US 2009/0182116 A1
(43) Pub. Date: Jul. 16, 2009

(54) MANUFACTURE OF PHOSPHORUS-CONTAINING DIAMINES AND THEIR DERIVATIVES

(75) Inventors: Ching-Hsuan LIN, Taichung City (TW); Chia Wei CHANG, Taichung City (TW); Tsung Li LIN, Taichung City (TW)

Correspondence Address: CONNOLLY BOVE LODGE & HUTZ, LLP, P O BOX 2207, WILMINGTON, DE, 19899, US

(73) Assignee: National Chung Hsing University, Taichung City (TW)

(21) Appl. No.: 12/353,460

(22) Filed: Jan. 14, 2009

(30) Foreign Application Priority Data
Jan. 15, 2008 (TW) 097101541

(51) Int. Cl. C08G 69/42; C07F 9/28

(52) U.S. Cl. 528/352; 549/219; 548/415; 564/16

(57) ABSTRACT

A series of novel phosphorus-containing compounds having the following formula are disclosed:

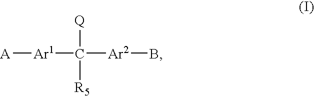

wherein
Q, R₅, Ar¹, Ar², A, and B are as defined in the specification.

The present invention provides a process for the preparation of the compound of formula (I). The present invention also provides a compound of formula (PA) and a process for preparing the same. The present invention further provides a compound of formula (PI) and a process for preparing the same.

### FIELD OF THE INVENTION

The present invention relates to a series of phosphorus-containing compounds and the manufacture process thereof, and more particularly, to the compounds of phosphorus-containing diphenylamine and the manufacture process thereof. These compounds are applicable to the synthesis of epoxy resin and bismaleimide and capable of being polymerized into polymer materials such as polyamide and polyimide.

### DESCRIPTION OF THE PRIOR ART

Since ancient times, fire has posed a serious threat to human life and property. Fireproof materials for different places and public facilities are different. Halogen-containing compounds are mostly added to conventional fireproof and flame resistant materials to form compositions having high heat resistance. Although the materials have a considerable combustion inhibiting effect, they are likely to generate corrosive and toxic substances such as dioxin, which may cause human metabolic disturbance resulting in diseases such as tension, sleep disorders, headache, eye diseases, arteriosclerosis, and liver tumors. Furthermore, in animal experiments, it was found that such materials would result in cancers.

In recent years, organophosphorus compounds have been studied. It has been found that organophosphorus compounds have good flame resistance for polymers and will not generate smoke, namely, toxic gas, in comparison with halogen-containing flame resistant agents. Additionally, organophosphorus compounds have advantages of excellent processability, small addition amount, low smoke generation and so on. Especially, when the reactive organophosphorus groups are introduced into the main structures of the polymers, the polymers will have a better flame resistant effect.

Phosphorus-containing compounds such as 9,10-dihydro-9-oxa-10-phosphaphenanthrene-10-oxide (DOPO) have active hydrogen atoms which can react with electron-deficient compounds such as benzoquinone [1], oxirane [2], maleic acid [3], bismaleimide [4], diaminobenzophenone [5-6], and terephthaldicarboxaldehyde [7]. The derivatives of the phosphorus-containing compounds attract much attention from academic communities and the industry. DOPO-derived compounds can be used as raw materials of polymer materials such as epoxy resin, polyimide, and polyamide.

The present invention utilizes organophosphorous compounds' ability to react with ketones and develops a series of phosphorus-containing compounds, especially phosphorus-containing diaminie compounds, which are used as raw materials of polymer materials such as epoxy resin, bismaleimide, polyimide, and polyamide.

### REFERENCES

[1] Wang, C. S.; Lin, C. H. Polymer 1999; 40; 747.
[2] Lin, C. H.; Wang, C. S. Polymer 2001, 42, 1869.
[3] Wang, C. S.; Lin, C. H.; Wu, C. Y. J. Appl. Polym. Sci. 2000, 78, 228.
[4] Lin, C. H.; Wang, C. S. J. Polym. Sci. Part A: Polym. Chem. 2000, 38, 2260.
[5] Liu, Y. L.; Tsai, S. H. Polymer 2002, 43, 5757.
[6] Wu, C. S.; Liu, Y. L.; Chiu, Y. S. Polymer 2002, 43, 1773.
[7] Liu, Y. L.; Wu, C. S.; Hsu, K. Y.; Chang, T. C. J. Polym. Sci. Part A: Polym Chem. 2002, 40, 2329.

### SUMMARY OF THE INVENTION

The present invention provides phosphorus-containing compounds having the following chemical formula:

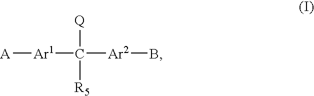

wherein
Q is

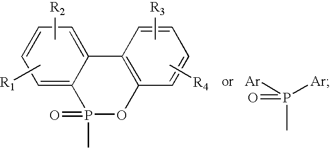

R₁-R₄ are independently selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, and halogen;
R₅ is selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, halogen, and —Ar³;
Ar is

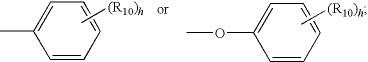

Ar¹ and Ar² are independently selected from the group consisting of:

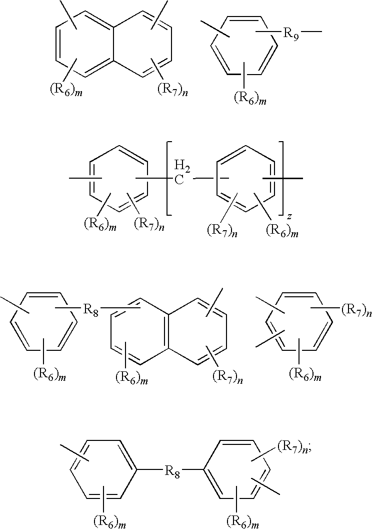

Ar³ is selected from the group consisting of:

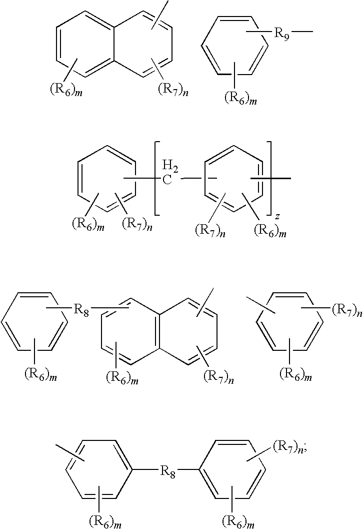

R₆ is selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, and halogen;
R₇ is selected from the group consisting of —OH, —NH₂, —NO₂, —SH, —COOH, —SO₃H, —COH, —NHCOCH₃, and —OCH₃;
R₈ is selected from the group consisting of —CH₂—, —(CH₃)₂CH₂—, —CO—, —SO₂—, —O—, and —NH—, or is absent;
R₉ is —(CH₂)p-, or is absent;
R₁₀ is C₁-C₄ alkyl or C₆-C₁₈ aryl;
m and n are each an integer of 0-4;
z and p are each an integer of 1-20;
h is an integer of 0 to 5;
A and B are independently selected from the group consisting of —NO₂, —NH₂,

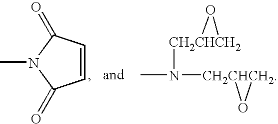

The present invention provides a process of preparing the compound of formula (I), which includes reacting an organophosphorous compound of formula (II) and a compound of formula (III) with a compound of formula (IV) in the presence of an acid catalyst to form the compound of formula (I):

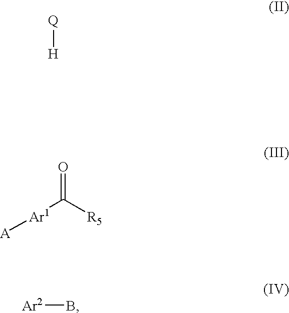

wherein Q, Ar¹, Ar², A, B, and R₅ are defined as above.

The present invention also provides a compound of formula (PA) and a process for preparing the same. The present invention further provides a compound of formula (PI) and a process for preparing the same.

### BRIEF DESCRIPTION OF THE DRAWINGS

FIG. 1 is a ¹H NMR spectrum of compound B.

FIG. 2 is a ¹³C NMR spectrum of compound B.

FIG. 3 is a ³¹P NMR spectrum of compound B.

FIG. 4 is a MASS spectrum of compound B.

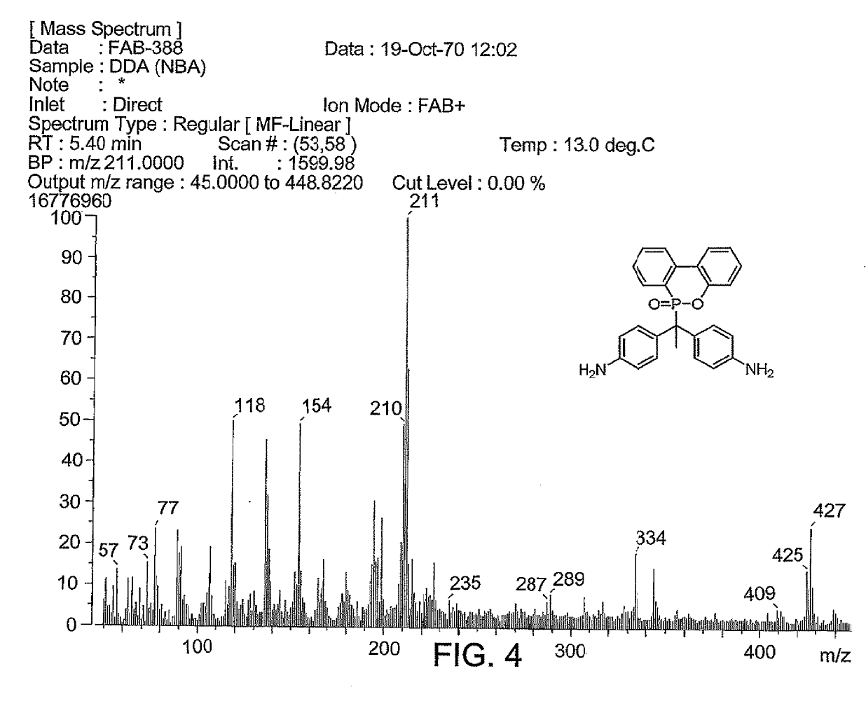

FIG. 5 is a ¹H NMR spectrum of compound C.

FIG. 6 is a ¹³C NMR spectrum of compound C.

FIG. 7 is a ³¹P NMR spectrum of compound C.

### DETAILED DESCRIPTION OF THE INVENTION

The present invention is directed to a series of novel phosphorus-containing compounds which can be used as raw materials of polymer materials such as epoxy resin, polyamide, and polyimide. The polymer materials can be further applied to flame resistant materials.

The present invention provides phosphorus-containing compounds having the following chemical formula:

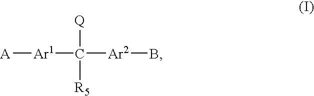

wherein
Q is

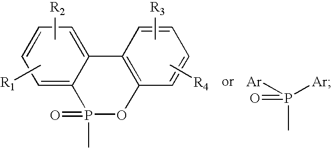

R₁-R₄ are independently selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, and halogen;
R₅ is selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, halogen, and —Ar³;
Ar is

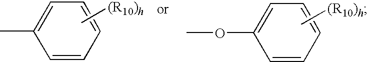

Ar¹ and Ar² are independently selected from the group consisting of:

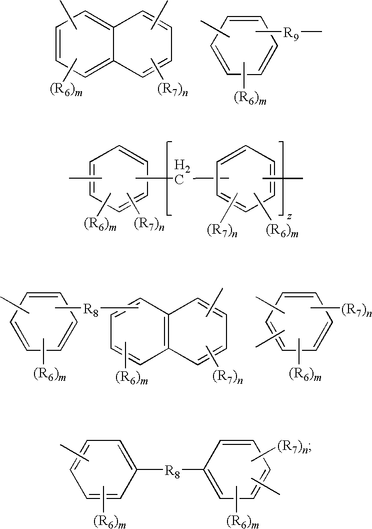

Ar³ is selected from the group consisting of:

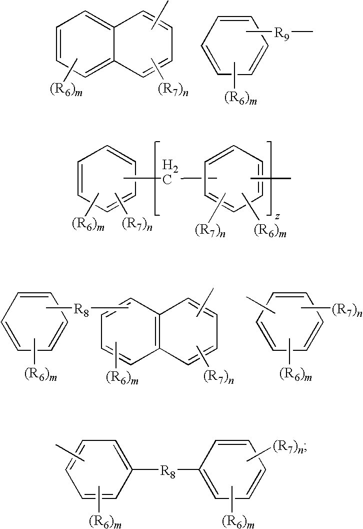

R₆ is selected from the group consisting of H, C₁-C₁₀ alkyl, C₁-C₁₀ alkoxy, C₁-C₁₀ halo-alkyl, C₃-C₁₀ cycloalkyl, —CF₃, —OCF₃, and halogen;
R₇ is selected from the group consisting of —OH, —NH₂, —NO₂, —SH, —COOH, —SO₃H, —COH, —NHCOCH₃, and —OCH₃;
R₈ is selected from the group consisting of —CH₂—, —(CH₃)₂CH₂—, —CO—, —SO₂—, —O—, and —NH—, or is absent;
R₉ is —(CH₂)p-, or is absent;
R₁₀ is C₁-C₄ alkyl or C₆-C₁₈ aryl;
m and n are each an integer of 0-4;
z and p are each an integer of 1-20;
h is an integer of 0 to 5;
A and B are independently selected from the group consisting of —NO₂, —NH₂,

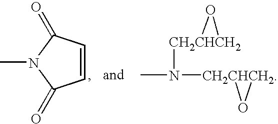

When Q is

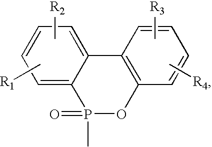

R₁-R₄ are hydrogen, Ar¹ and Ar² are each phenyl, R₅ is hydrogen, A is —NO₂, and B is —NH₂, an embodiment of the compound of formula (I) can have a structural formula of

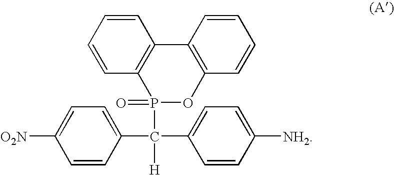

When Q is

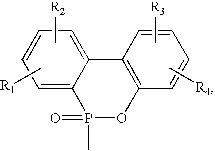

R₁-R₄ are hydrogen, Ar¹ and Ar² are each phenyl, R₅ is hydrogen, and A and B are —NH₂, an embodiment of the compound of formula (I) can have a structural formula of

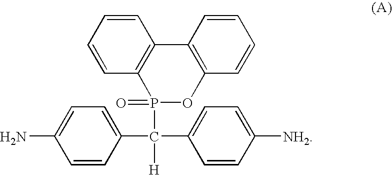

When Q is

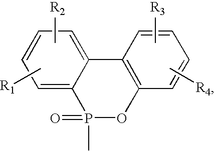

R₁-R₄ are hydrogen, Ar¹ and Ar² are each phenyl, R₅ is hydrogen, and A and B are

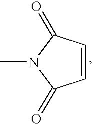

an embodiment of the compound of formula (I) can have a structural formula of

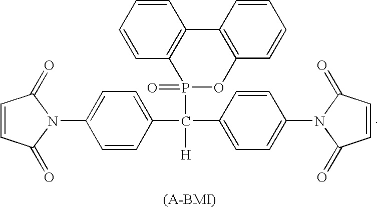

When Q is

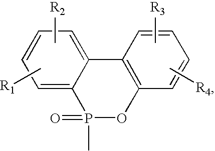

R₁-R₄ are hydrogen, Ar¹ and Ar² are each phenyl, R₅ is hydrogen, and A and B are

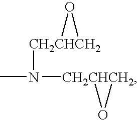

an embodiment of the compound of formula (I) can have a structural formula of

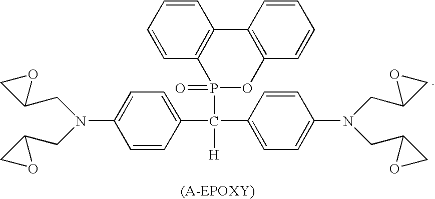

When Q is

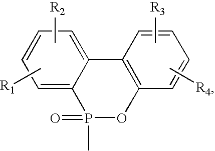

R₁-R₄ are hydrogen, Ar¹ and Ar² are each phenyl, R₅ is methyl, and A and B are —NH₂, an embodiment of the compound of formula (I) can have a structural formula of

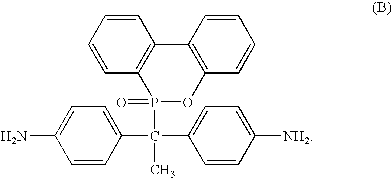

When Q is

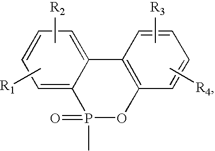

R₁-R₄ are hydrogen, Ar¹ and Ar² are each phenyl, R₅ is methyl, and A and B are

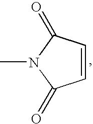

an embodiment of the compound of formula (I) can have a structural formula of

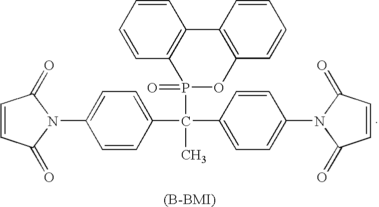

When Q is

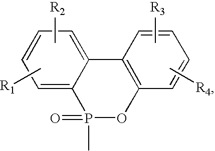

R₁-R₄ are hydrogen, Ar¹ and Ar² are each phenyl, R₅ is methyl, and A and B are

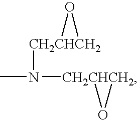

an embodiment of the compound of formula (I) can have a structural formula of

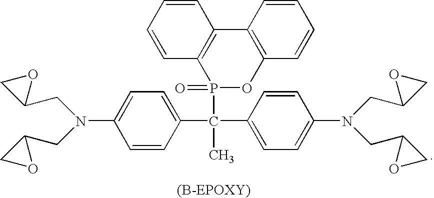

When Q is

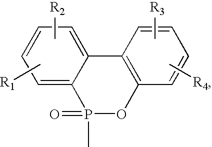

R₁-R₄ are hydrogen, Ar¹ and Ar² are each phenyl, R₅ is phenyl, and A and B are —NH₂, an embodiment of the compound of formula (I) can have a structural formula of

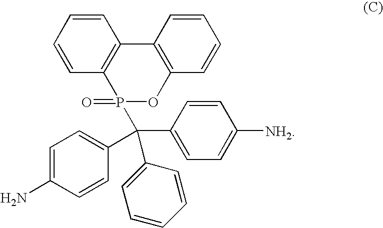

When Q is

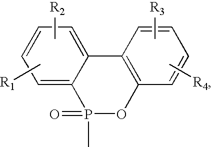

R₁-R₄ are hydrogen, Ar¹ and Ar² are each phenyl, R₅ is phenyl, and A and B are

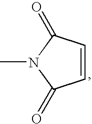

an embodiment of the compound of formula (I) can have a structural formula of

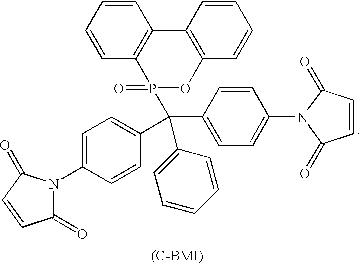

When Q is

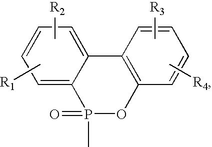

R₁-R₄ are hydrogen, Ar¹ and Ar² are each phenyl, R₅ is phenyl, and A and B are

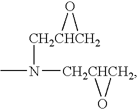

an embodiment of the compound of formula (I) can have a structural formula of

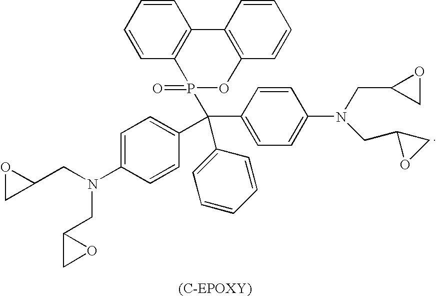

When Q is

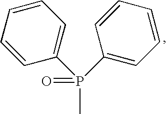

Ar¹ and Ar² are each phenyl, R₅ is methyl, and A and B are —NH₂, an embodiment of the compound of formula (I) can have a structural formula of

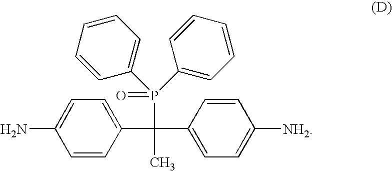

When Q is

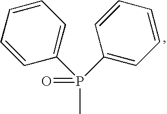

Ar¹ and Ar² are each phenyl, R₅ is methyl, and A and B are

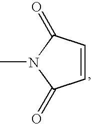

an embodiment of the compound of formula (I) can have a structural formula of

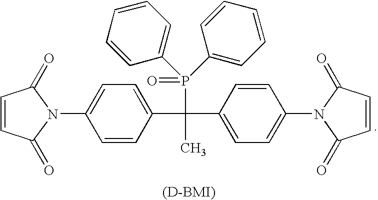

When Q is

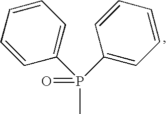

Ar¹ and Ar² are each phenyl, R₅ is methyl, and A and B are

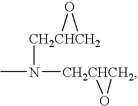

an embodiment of the compound of formula (I) can have a structural formula of

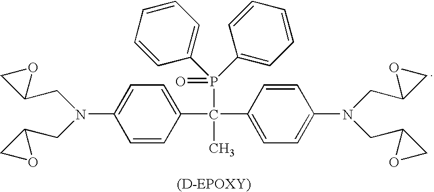

The present invention provides a process of preparing the compound of formula (I), which includes reacting an organophosphorous compound of formnula (II) and a compound of formula (III) with a compound of formula (IV) in the presence of an acid catalyst to forin the compound of formula (I):

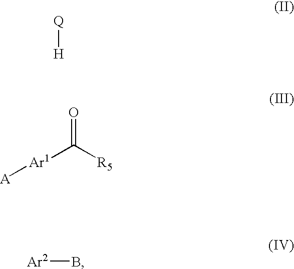

wherein Q, Ar¹, Ar², A, B and R₅ are defined as above.

In the process described above, where Q is

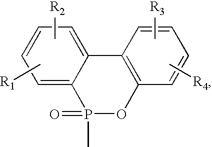

R₁-R₄ are hydrogen, and Ar¹ and Ar² are each phenyl, the steps of the process include:
(a) when A is —NO₂, B is —NH₂, and R₅ is hydrogen atom,
   (i) reacting 9,10-dihydro-9-oxa-10-phosphaphenanthrene-10-oxide (DOPO) of formula (II) with the compound of formula (III);
   (ii) adding a compound of formula (IV) and the acid catalyst to form a compound of formula (A′);
   (iii) hydrogenating the compound of formula (A′) in a solvent to form the product, the compound of formula (A);
(b) when A and B are —NH₂, R₅ is methyl or phenyl,
   (i) reacting 9,10-dihydro-9-oxa-10-phosphaphenanthrene-10-oxide (DOPO) of formula (II) and the compound of formula (III) with the compound of formula (IV) in the presence of the acid catalyst to form a compound of formula (B) or formula (C).

In the process described above, where Q is

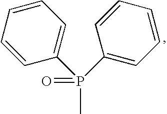

Ar¹ and Ar² are each phenyl, A and B are —NH₂, and R₅ is methyl, the diphenylphosphine oxide of formula (II) and the compound of formula (III) are reacted with the compound of formula (IV) in the presence of the acid catalyst to form a compound of formula (D).

The acid catalyst used in the process described above is selected from the group consisting of protic acids or Lewis acids.

The acid catalyst used in the process described above is selected from the group consisting of acetic acid, p-toluenesulfonic acid, methanesulfonic acid, calmagite, sulfuric acid, orthanilic acid, 3-pyridinesulfonic acid, sulfanilic acid, hydrogen chloride (HCl), hydrogen bromide (HBr), hydrogen iodide (HI), hydrogen fluoride (HF), trifluoroacetic acid (CF₃COOH), nitric acid (HNO₃), phosphoric acid (H₃PO₄), aluminum chloride (AlCl₃), boron fluoride (BF₃), ferric bromide (FeBr₃), ferric chloride (FeCl₃), boron chloride (BCl₃), and titanium chloride (TiCl₄).

The amount of the acid catalyst used in the process described above is 0.1 wt %-30 wt % of the amount of the organophosphorous compound of formula (II).

The solvent used in the process described above is dimethylformamide (DMF).

The present invention provides phosphorus-containing polyamides having the following chemical formula:

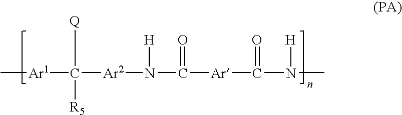

wherein Q, Ar¹, Ar² and R₅ are defined as above, Ar¹ is selected from the group consisting of

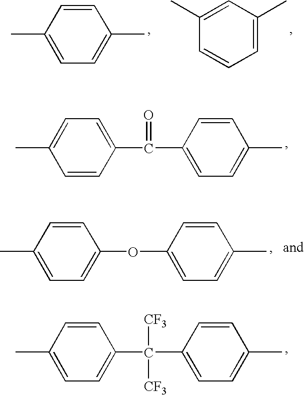

n is an integer of 30-300.

When Q is

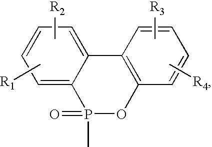

R₁-R₄ are hydrogen, Ar¹, Ar² and Ar′ are each phenyl, and R₅ is hydrogen, an embodiment of the compound of formula (PA) can have a structural formula of

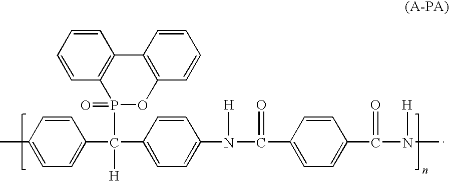

When Q is

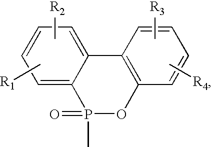

R₁-R₄ are hydrogen, Ar¹, Ar² and Ar′ are each phenyl, and R₅ is methyl, an embodiment of the compound of formula (PA) can have a structural formula of

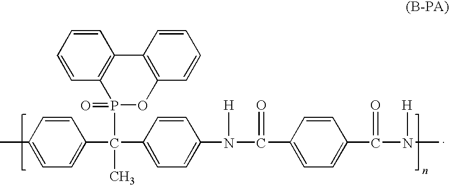

When Q is

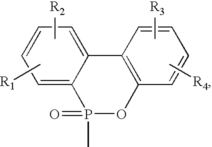

R₁-R₄ are hydrogen atom, Ar¹, Ar² and Ar′ are each phenyl, and R₅ is phenyl, an embodiment of the compound of formula (PA) can have a structural formula of

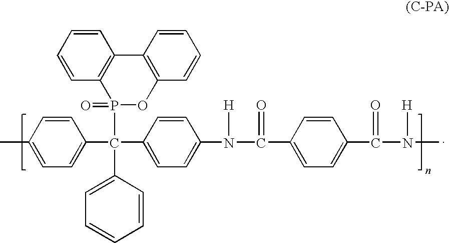

When Q is

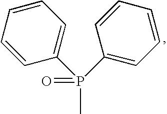

Ar¹, Ar² and Ar′ are each phenyl, and R₅ is methyl, an embodiment of the compound of formula (PA) can have a structural formula of

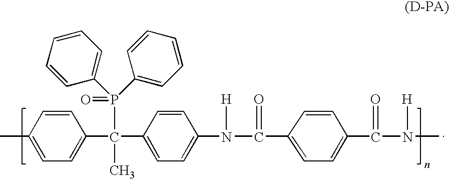

The present invention provides a process of preparing the phosphorus-containing polyamides of formula (PA), which includes reacting a compound of formula (I) with a diacid compound of formula (V) in a solvent to form the phosphorus-containing polyamides of formula (PA):

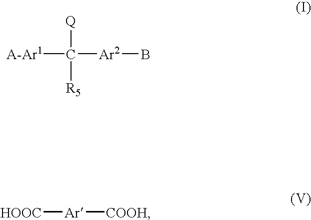

wherein Q, Ar¹, Ar², A, B, and R₅ are defined as above, Ar¹ is selected from the group consisting of

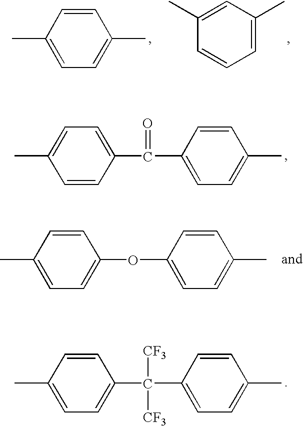

The solvent used in the process described above is N-methylpyrrolidone (NMP).

Calcium chloride can also be used in the process described above.

Triphenyl phosphite (TPP) can also be used in the process described above.

Pyridine can also be used in the process described above.

The present invention further provides phosphorus-containing polyimides having the following chemical formula:

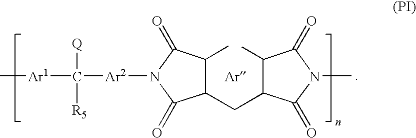

wherein Q, Ar¹, Ar², and R₅ are defined as above, Ar″ is selected from the group consisting of

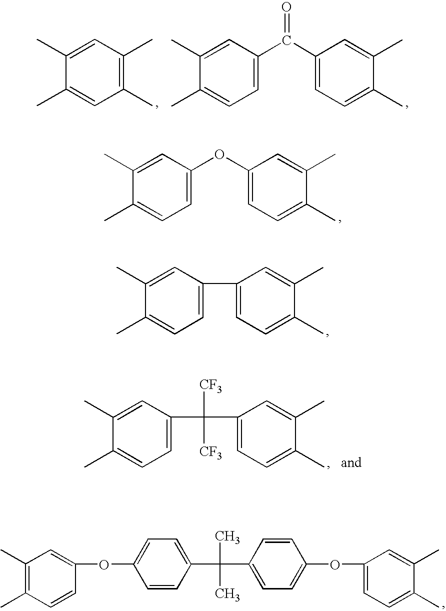

and n is an integer of 30-300.

When Q is

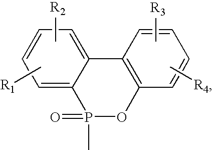

R₁-R₄ are hydrogen, Ar¹ and Ar² are each phenyl, Ar″ is

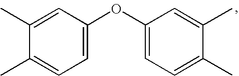

and R₅ is hydrogen, an embodiment of the compound of formula (PI) can have a structural formula of

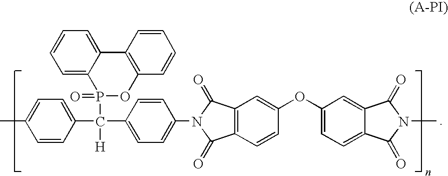

When Q is

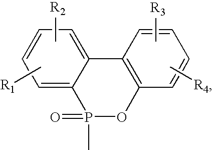

R₁-R₄ are hydrogen, Ar¹ and Ar² are each phenyl, Ar″ is

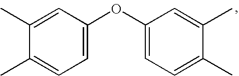

and R₅ is methyl, an embodiment of the compound of formula (PI) can have a structural formula of

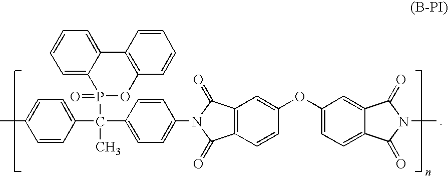

When Q is

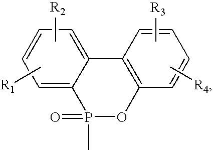

R₁-R₄ are hydrogen, Ar¹ and Ar² are each phenyl, Ar″ is

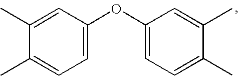

and R₅ is phenyl, an embodiment of the compound of formula (PI) can have a structural formula of

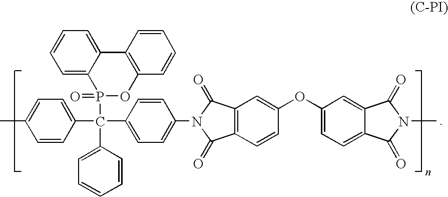

When Q is

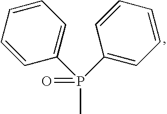

Ar¹ and Ar² are each phenyl, Ar″ is

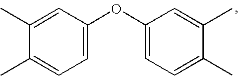

and R₅ is methyl, an embodiment of the compound of formula (PI) can have a structural formula of

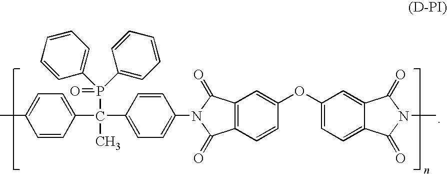

The present invention further provides a process of preparing the phosphorus-containing polyimides of formula (PI), which includes reacting a compound of formula (I) with a dianhydride compound of formula (VI) in a solvent to form the phosphorus-containing polyimides of fornula (PI):

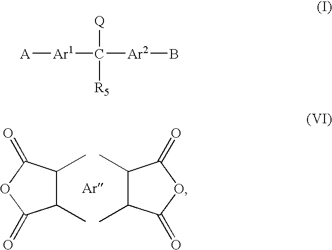

wherein Q, Ar¹, Ar², A, B, and R₅ are defined as above, Ar″ is selected from the group consisting of

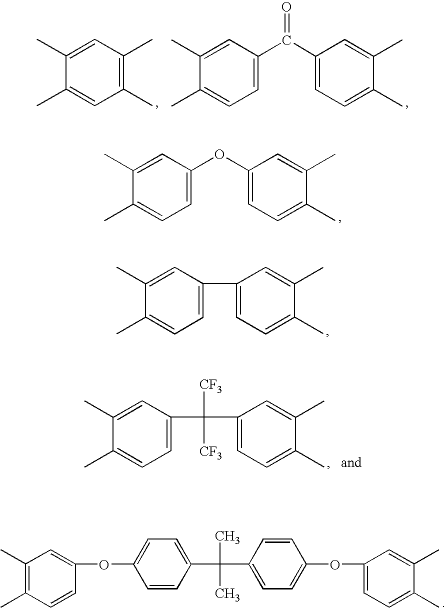

The solvent used in the process described above is m-cresol.

### EXAMPLES

The following embodiments are used to further illustrate the present invention, but are not intended to limit the scope of the present invention. Any modifications and changes achieved by those skilled in the art without departing from the spirit of the present invention will fall within the scope of the present invention.

Accordingly, specific embodiments of the implementation of the present invention described above are illustrated below.

### Example 1

Synthesis of Compound A′

The phosphorus-containing compound A′, wherein Q

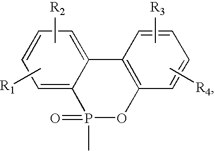

R₁-R₄ are each hydrogen, Ar¹ and Ar² are each phenyl, R₅ is hydrogen, A is —NO₂, and B is —NH₂, is synthesized with particular DOPO, aniline, 4-nitrobenzaldehyde, and an acid catalyst, The synthesis steps are as follows: 10.81 g (0.05 mol) of an organic cyclic phosphorus compound (9,10-dihydro-9-oxa-10-phosphaphenanthrene-10-oxide, DOPO) and 8.26 g (0.05 mol) of p-nitroacetophenone were placed in a 250 ml three-necked reactor, and then, the reaction temperature was raised to 110° C. After 6 hours of reaction, 23.28 g (0.25 mol) of aniline and 0.216 g (2 wt % of DOPO) of p-toluenesulfonic acid were added to the reactor, the temperature was raised to 130° C., and the reaction was continued for 18 hours. After the reaction was completed, the stirring was stopped, and the reactor was cooled to room temperature. The product was dissolved with methanol, precipitated by adding water, filtered, and dried to give the product A′. The yield is 90%, and the melting point is 178° C.

### Example 2

### Synthesis of Compound A

The phosphorus-containing compound A, wherein Q is

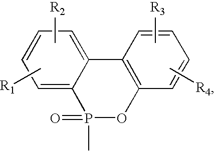

R₁-R₄ are each hydrogen, Ar¹ and Ar² are each phenyl, R₅ is hydrogen, and A and B is —NH₂, is synthesized with A′, hydrogen gas, Pd/C as catalyst, and dimethylformamide (DMF) as a solvent. The synthesis steps are as follows:
22.12 g (0.05 mol) of A′, 0.442 g (2 wt %) of Pd/C, and 120 ml of DMF were added into a 250 ml three-necked reactor, and reacted at 110° C. under normal atmosphere under hydrogen gas for 12 hours. After the reaction was completed, water was added to the reactor to obtain white powder. The yield is 93%, and the melting point is 225° C.

### Example 3

### Synthesis of Compound A-BMI

The compound A-BMI is synthesized with the phosphorus-containing compound A, wherein Q is

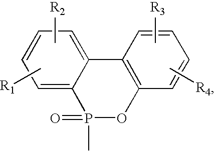

R₁-R₄ are each hydrogen, Ar¹ and Ar² are each phenyl, R₅ is hydrogen, and A and B are —NH₂. The synthesis steps are as follows:
20.62 g (0.05 mol) of A, 9.81 g (0.1 mol) of maleic anhydride, and 200 ml of acetone were added into a 500 ml reactor. After 4 hours of reaction in an ice bath, 50 ml of acetic anhydride and 8.50 g of sodium acetate were added to the reactor, The temperature was raised to 60° C. and the reaction was continued for 4 hours. The solvent was distilled off under reduced pressure. The product was precipitated with ethanol, and then recrystallized directly from ethanol to give the pure compound A-BMI.

### Example 4

Synthesis of Compound A-EPOXY

The compound A-EPOXY having epoxy group is synthesized with the phosphorus-containing compound A, wherein Q is

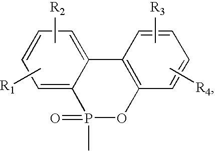

R₁-R₄ are each hydrogen, Ar¹ and Ar² are each phenyl, R₅ is hydrogen, and A and B are —NH₂. The synthesis steps are as follows:
103 g of A and 925 g of epichlorohydrin were added into a 3 L reactor, and stirred to form a uniformly mixed solution under normal atmosphere. The reaction temperature was raised to 70° C. at an absolute pressure of 190 mmEg, and 200 g of 20% sodium hydroxide solution was added into the reactor in batches in 4 hours. At the same time, water in the reactor was removed by azeotropic distillation. After the reaction was completed, the epichlorohydrin and the solvent were completely distilled off under reduced pressure. The product was dissolved with methyl ethyl ketone and deionized water. Sodium chloride in the resin was washed off with water, and the solvent was completely distilled off under reduced pressure to obtain khaki epoxy group-containing A-EPOXY. The epoxy equivalent is 302.

### Example 5

Synthesis of Polymer A-PA

The phosphorus-containing polyamide A-PA is synthesized with the phosphorus-containing compound A, wherein Q is

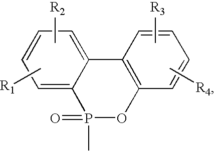

R₁-R₄ are each hydrogen, Ar¹ and Ar² are each phenyl, R₅ is hydrogen, and A and B are —NH₂. The synthesis steps are as follows:
First, nitrogen gas was fed to a 100 ml three-necked flask for 30 minutes. 0.5155 g (1.25 mmol) of A, 0.2079 g (1.25 mmol) of terephthalic acid, 0.3 g of calcium chloride (CaCl₂), 0.9 ml of triphenyl phosphite (TPP), 1.2 ml of pyridine, and 5 ml N-methylpyrrolidone (NMP) were added to the flask and stirred. The flask was heated to 100° C., the reaction was continued for 4 hours, and then the flask was cooled to room temperature. After the reaction, the polymer solution obtained was slowly poured into 300 ml of methanol and the product was precipitated. The resultant fibrous precipitate was filtered, and washed with methanol and hot water. The product was collected and dried at 150° C. to obtain 0.5872 g. Next, the synthesized polyetheramide polymer was dissolved in DMAc or NMP, so that the solid content of the solution was about 20%. The polyamide solution was coated onto a glass substrate by a coater and the film thickness was controlled at about 45 μm. The glass substrate was treated in a hot air circulating oven at 80° C. for 12 hours to remove most of the solvent, followed by further treatment at 200° C. for 2 hours. Finally, it was immersed in water to separate the A-PA thin film from the glass substrate. The glass transition temperature of the A-PA thin film measured by DSC was 253° C.

### Example 6

Synthesis of Polymer A-PI

The phosphorus-containing polyimide A-PI is synthesized with the phosphorus-containing compound A, wherein Q is

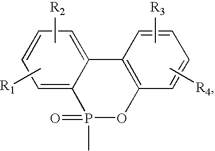

R₁-R₄ are each hydrogen, Ar¹ and Ar² are each phenyl, R₅ is hydrogen, and A and B are —NH₂. The synthesis steps are as follows:
0.6186 g (1.5 mmol) of the diamine monomer A, 0.4653 g (1.5 mmol) 4,4′-oxydiphthalic anhydride (ODPA), and 7.8 g of m-cresol were weighed and mixed in a 100 ml three-necked reactor. The reaction temperature was raised to 200° C. The reaction was continued for 2 hours and the reactants were poured into methanol. Precipitate was formed and filtered. The resultant precipitate was collected and washed with hot methanol for 24 hours. The precipitate was filtered and dried at 100° C. to obtain 0.9110 g of the product. The dried product was dissolved in DMF, so that the solid content of the solution was about 20%. The polyimide solution was coated onto a glass substrate by a coater and the film thickness was controlled at about 20 μm. The glass substrate was treated in a hot air circulating oven at 80° C. for 12 hours to remove most of the solvent, followed by further treatment at 200° C. for 2 hours. The glass transition temperature was measured by DSC was 262° C.

The implementation of the present invention described above can be illustrated by Scheme 1 shown below.

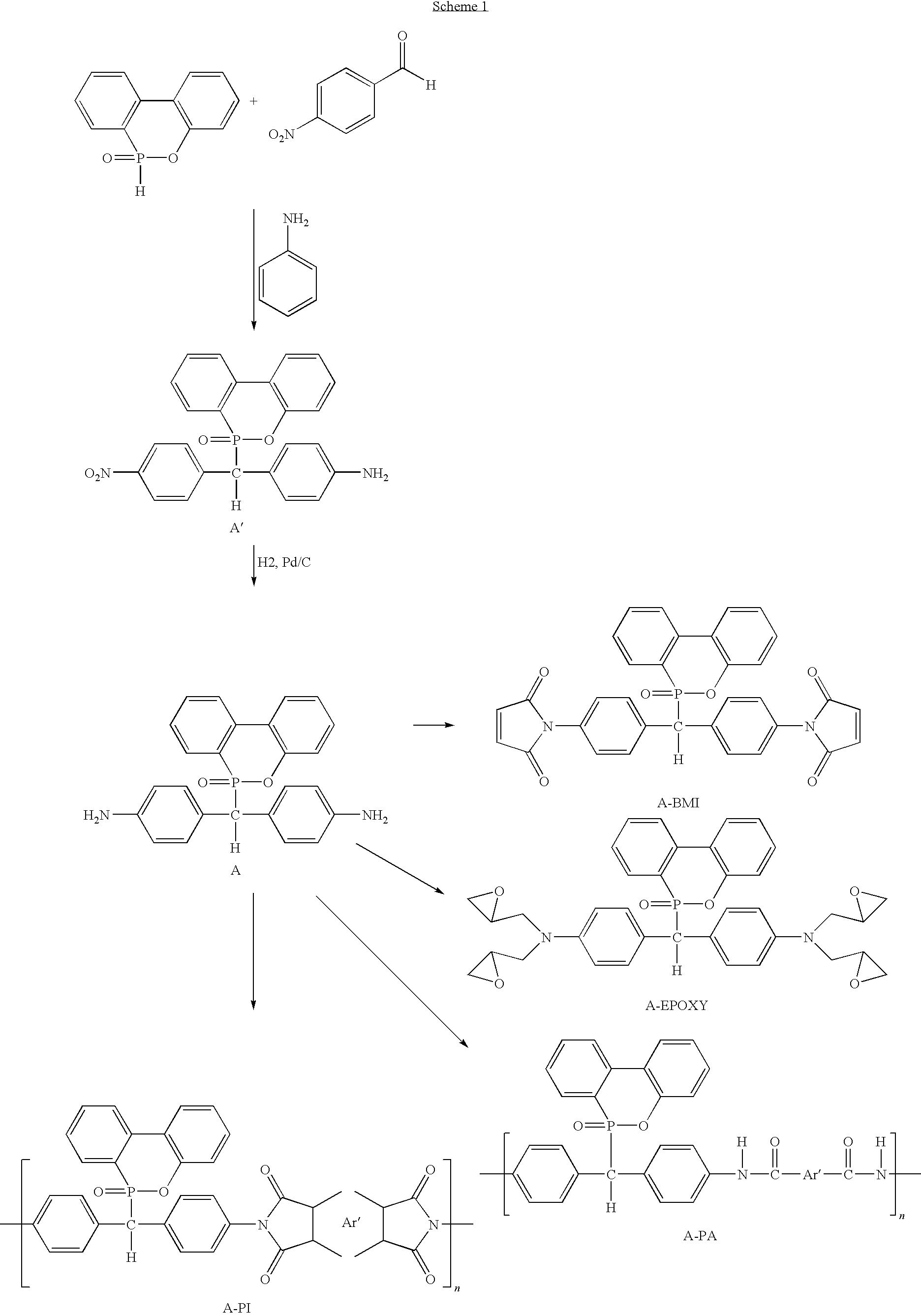

### Example 7

Synthesis of Compound B

The phosphorus-containing compound B, wherein Q is

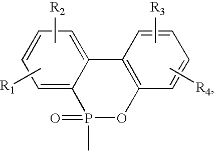

R₁-R₄ are each hydrogen, Ar¹ and Ar² are each phenyl, R₅ is methyl, and A and B are —NH₂, is synthesized with particular DOPO, aniline, 4′-aminoacetophenone, and an acid catalyst. The synthesis steps are as follows:
10.81 g (0.05 mol) of an organic cyclic phosphorus compound (9,10-dihydro-9-oxa-10-phosphaphenanthrene-10-oxide, DOPO), 23.28 g (0.25 mol) of aniline, 6.76 g (0.05 mol) of 4′-aminoacetophenone, and 0.216 g (2 wt % of DOPO) of p-toluenesulfonic acid were placed in a 250 ml three-necked reactor.

Next, the reaction temperature was raised to 130° C. The reaction was continued for 24 hours and the stirring was stopped. The reactor was cooled to room temperature. The product was dissolved with methanol, precipitated by adding water, filtered, and dried to obtain the product B. The yield is 75%, and the melting point is 161° C. The elemental analysis results are as follows:

| | N % | C % | H % |
|---|---|---|---|
| Experimental | 6.54% | 73.29% | 5.61% |
| Value | | | |
| Predicted Value | 6.57% | 73.23% | 5.44% |

(Molecular weight of C₂₆H₂₃N₂O₂P = 426)

Predicted Value of high resolution MASS is 426.1497.

Measured value of high resolution MASS is 426.1568.

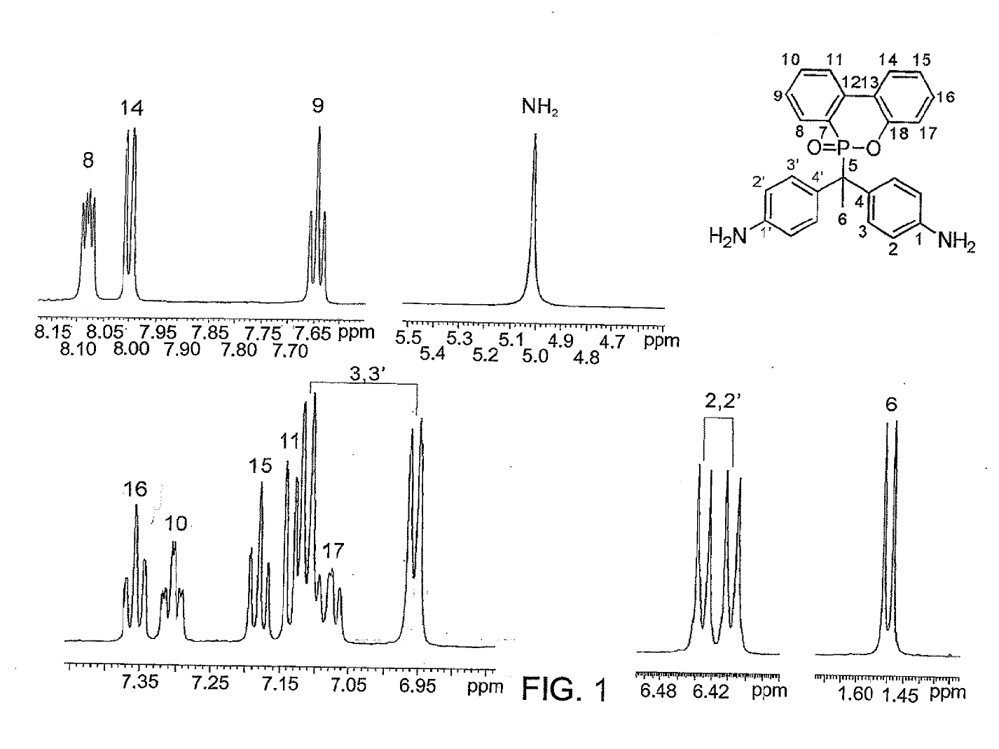

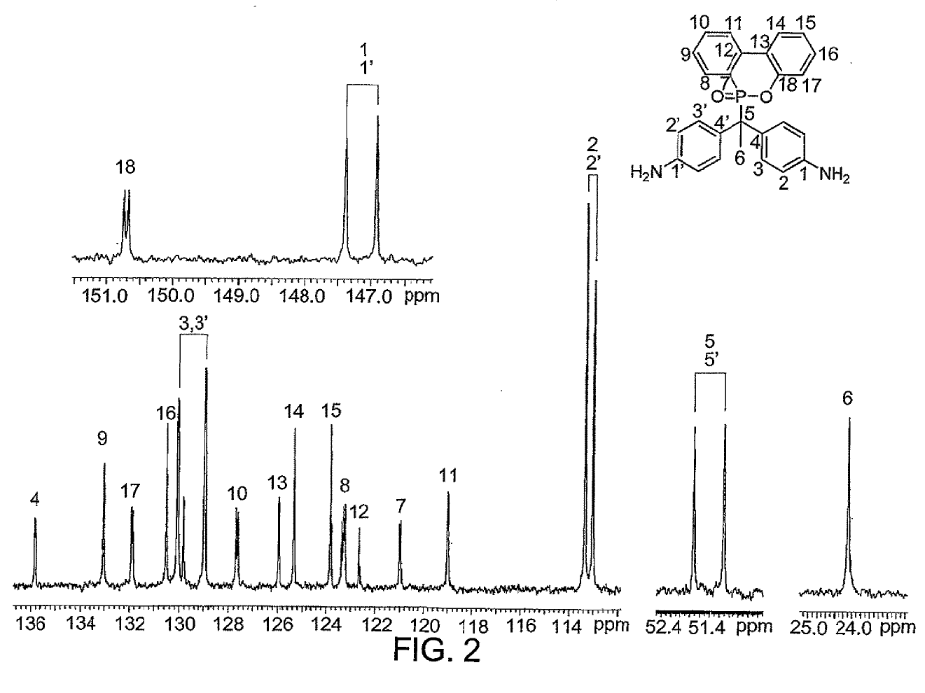

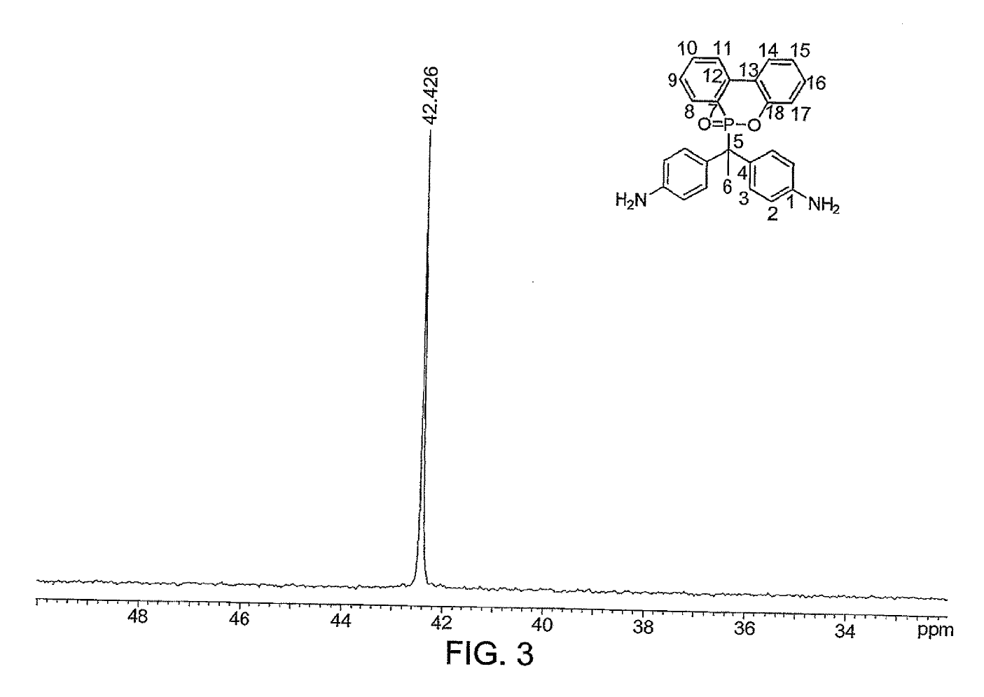

¹H NMR spectrum, ¹³C NMR spectrum, and ³¹P NMR spectrum of B are shown in FIGS. 1, 2, and 3 respectively.

### Example 8

Synthesis of Compound B-BMI

The compound B-BMI is synthesized with the phosphorus-containing compound B, wherein Q is

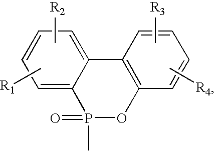

R₁-R₄ are each hydrogen, Ar¹ and Ar² are each phenyl, R₅ is methyl, and A and B are —NH₂. The synthesis steps are as follows:
21.32 g (0.05 mol) of X, 9.81 g (0.1 mol) of maleic anhydride, and 200 ml of acetone were added into a 500 ml reactor. After 4 hours of reaction in an ice bath, 50 ml of acetic anhydride and 8.50 g of sodium acetate were added into the reactor. The temperature was raised to 60° C. and the reaction was continued for 4 hours. The solvent was distilled off under reduced pressure, and the product was precipitated with ethanol. The product was then recrystallized directly from ethanol to give the pure compound B-BMI.

### Example 9

Synthesis of Compound B-EPOXY

The compound B-EPOXY having epoxy group is synthesized with the phosphorus-containing compound B, wherein Q is

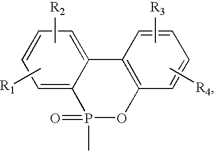

R₁-R₄ are each hydrogen, Ar¹ and Ar² are each phenyl, R₅ is methyl, and A and B are —NH₂. The synthesis steps are as follows:
107 g of B and 925 g of epichlorohydrin were added into a 3 L reactor and stirred to form a uniformly mixed solution under normal atmosphere. The reaction temperature was raised to 70° C. under an absolute pressure of 190 mmHg, and 200 g of 20% sodium hydroxide solution was added into the reactor in batches in 4 hours. At the same time, water in the reactor was removed by azeotropic distillation. After the reaction was completed, the epichlorohydrin and the solvent were completely distilled off under reduced pressure. The product was dissolved with methyl ethyl ketone and deionized water. Sodium chloride in the resin was washed off with water, and the solvent was completely distilled off under reduced pressure to obtain light yellow epoxy group-containing B-EPOXY. The epoxy equivalent is 290.

### Example 10

Synthesis of Polymer B-PA

The phosphorus-containing polyamide B-PA is synthesized with the phosphorus-containing compound B, wherein Q is

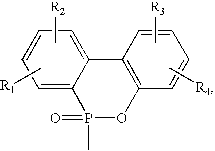

R₁-R₄ are each hydrogen atom, Ar¹ and Ar² are each phenyl, R₅ is methyl, and A and B are —NH₂. The synthesis steps are as follows:
First, nitrogen gas was fed to a 100 ml three-necked flask for 30 minutes. 0.5331 g (1.25 mmol) of B, 0.2079 g (1.25 mmol) of terephthalic acid, 0.3 g of calcium chloride (CaCl₂), 0.9 ml of triphenyl phosphite (TPP), 1.2 ml of pyridine, and 5 ml N-methylpyrrolidone (NMP) were added into the flask and stirred. The flask was heated to 100° C., the reaction was continued for 4 hours, and then the flask was cooled to room temperature. After the reaction, the polymer solution obtained was slowly poured into 300 ml of methanol and the product was precipitated. The resultant fibrous precipitate was filtered, washed with methanol and hot water. The product was collected and dried at 150° C. to obtain 0.6973 g. Next, the synthesized polyetheramnide polymer was dissolved in DNMAc or NMP, so that the solid content of the solution was about 20%. The polyamide solution was coated onto a glass substrate by a coater and the film thickness was controlled at about 45 μm. The glass substrate was treated in a hot air circulating oven at 80° C. for 12 hours to remove most of the solvent, followed by further treatment at 200° C. for 2 hours. Finally, it was immersed in water to separate the B-PA thin film from the glass substrate. The glass transition temperature of the B-PA thin film was measured by DSC was 232° C.

### Example 11

Synthesis of Polymer B-PI

The phosphorus-containing polyimide B-PI is synthesized with the phosphorus-containing compound B, wherein Q is

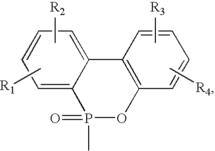

R₁-R₄ are each hydrogen, Ar¹ and Ar² are each phenyl, R₅ is methyl, and A and B are-NH₂. The synthesis steps are as follows:
0.6397 g (1.5 mmol) of the diamine monomer B, 0.4653 g (1.5 mmol) of ODPA, and 7.8 g of m-cresol were weighed and mixed in a 100 ml three-necked flask. The reaction temperature was raised to 200° C. The reaction was continued for 2 hours and the reactants were poured into methanol. Precipitate was formed and filtered. The resultant precipitate was washed with hot methanol for 24 hours. The precipitate was filtered and dried at 100° C. to obtain 0.9384 g of the product. The dried product was dissolved in DMF, so that the solid content of the solution was about 20%. The polyimide solution was coated onto a glass substrate by a coater and the film thickness was controlled at about 20 μm. The glass substrate was treated in a hot air circulating oven at 80° C. for 12 hours to remove most of the solvent, followed by further treatment at 200° C. for 2 hours. The glass transition temperature was measured by DSC was 318° C.

The implementation of the present invention described above can be illustrated by Scheme 2 shown below.

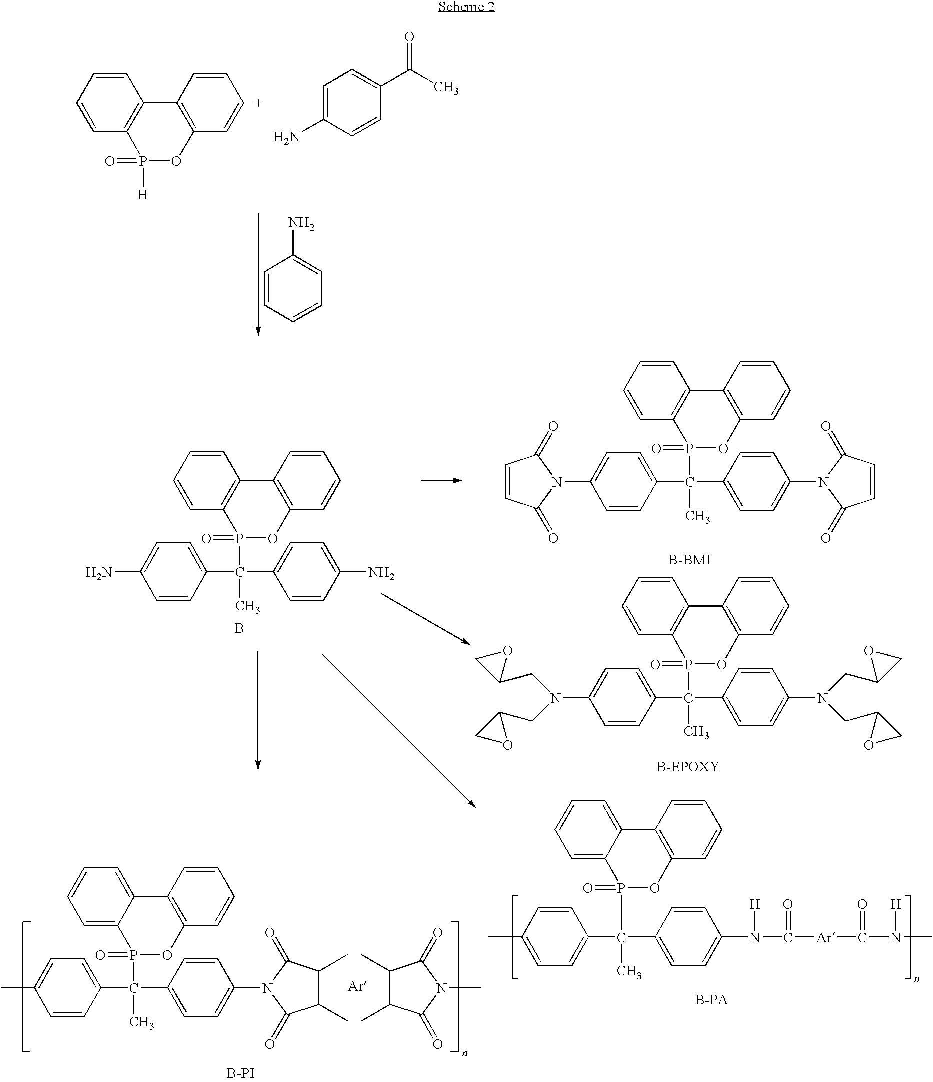

### Example 12

Synthesis of Compound C

The phosphorus-containing compound C, wherein Q is

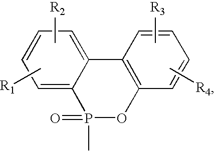

R₁-R₄ are each hydrogen, Ar¹, Ar², and R₅ are each phenyl, and A and B are —NH₂, is synthesized with particular DOPO, aniline, 4-aminobenzophenone, and an acid catalyst. The synthesis steps are as follows:
10.809 g (0.05 mol) of an organic cyclic phosphorus compound (9,10-dihydro-9-oxa-10-phosphaphenanthrene-10-oxide, DOPO), 23.281 g (0.25 mol) of aniline, 9.862 g (0.05 mol) of 4-aminobenzophenone, 0.216 g (2 wt % of DOPO) of p-toluenesulfonic acid were placed in a 250 ml three-necked reactor.

Next, the reaction temperature was raised to 130° C. The reaction was continued for 24 hours and the stirring was stopped. The reactor was cooled to room temperature. The product was dissolved with methanol, precipitated by adding water, filtered, and dried to give the product C. The yield is 75%, and the melting point is 314° C.

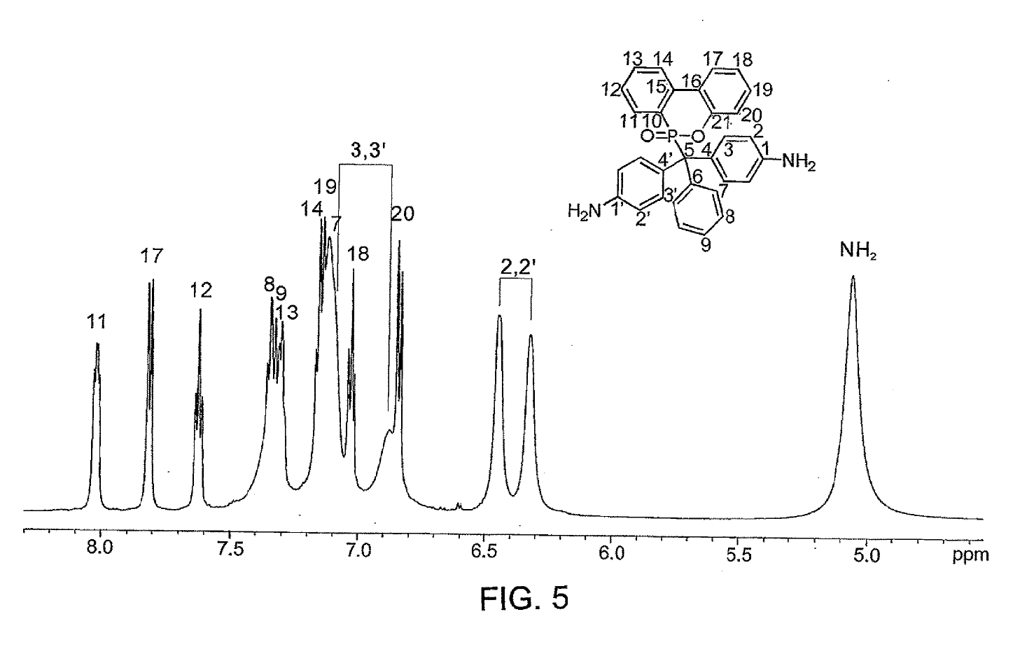

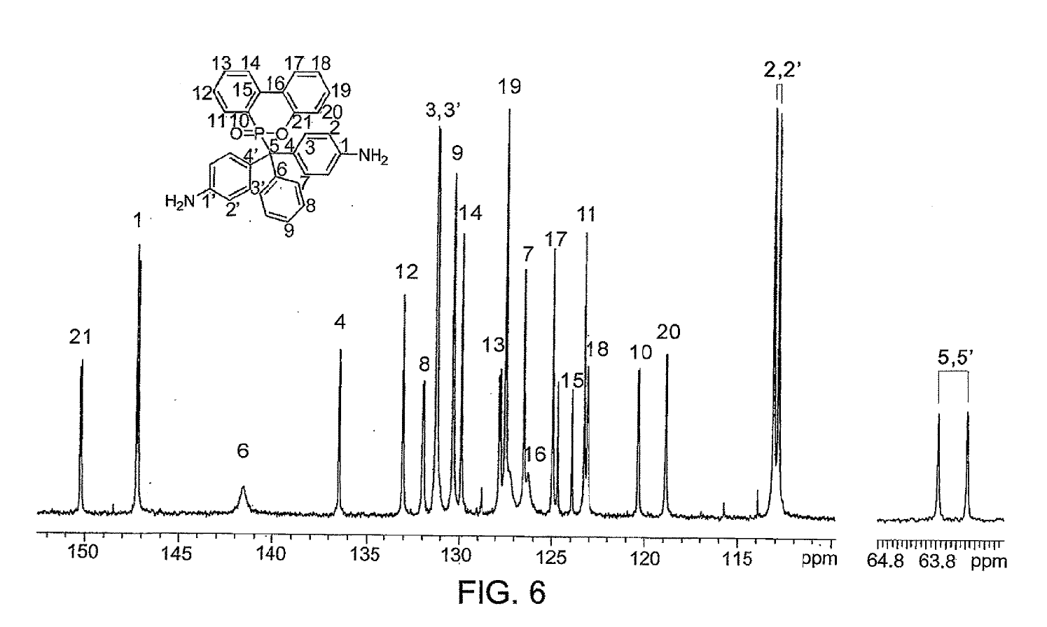

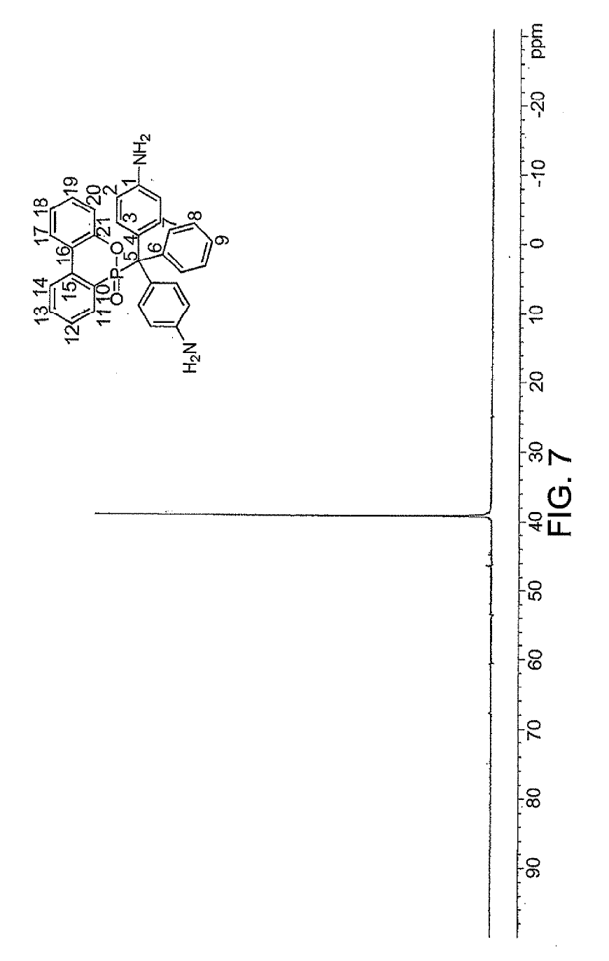

¹H NMR spectrum, ¹³C NMR spectrum, and ³¹p NMR spectrum of C are shown in FIGS. 5, 6, and 7 respectively.

### Example 13

Synthesis of Compound C-BMI

The compound C-BMI is synthesized with the phosphorus-containing diaminobenzene monomer C, wherein Q is

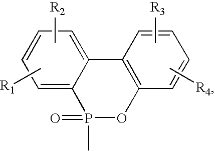

R₁-R₄ are each hydrogen, Ar¹, Ar², and R₅ are each phenyl, and A and B are —NH₂. The synthesis steps are as follows:
24.43 g (0.05 mol) of C, 9.81 g (0.1 mol) of maleic anhydride, and 200 ml of acetone were added into a 500 ml reactor. After 4 hours of reaction in an ice bath, 50 ml of acetic anhydride and 8.50 g of sodium acetate were added to the reactor. The temperature was raised to 60° C. and the reaction was continued for 4 hours. The solvent was distilled off under reduced pressure, and the product was precipitated with ethanol. The product was then recrystallized directly from ethanol to give the pure compound C-BMI.

### Example 14

Synthesis of Compound C-EPOXY

The compound C-EPOXY having epoxy group is synthesized with the phosphorus-containing compound C, wherein Q is

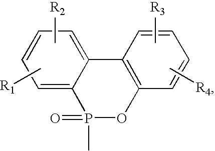

R₁-R₄ are each hydrogen, Ar¹, Ar², and R₅ are each phenyl, and A and B are —NH₂. The synthesis steps are as follows:
122 g of C and 925 g of epichlorohydrin were added into a 3 L reactor and stirred to form a uniformly mixed solution under normal atmosphere. The reaction temperature was raised to 70° C. under an absolute pressure of 190 mmHg, and 200 g of 20% sodium hydroxide solution was added to the reactor in batches in 4 hours. At the same time, water in the reactor was removed by azeotropic distillation. After the reaction was completed, the epichlorohydrin and the solvent were completely distilled off under reduced pressure, and the product was dissolved with methyl ethyl ketone and deionized water. Sodium chloride in the resin was washed off with water, and the solvent was completely distilled off under reduced pressure to obtain light green epoxy group-containing C-EPOXY. The epoxy equivalent is 334.

### Example 15

Synthesis of Compound C-PA

The phosphorus-conitaining polyamide C-PA is synthesized with the phosphorus-containing compound C, wherein Q is

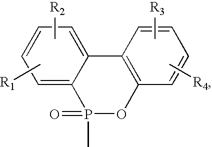

R₁-R₄ are each hydrogen, Ar¹, Ar², and R₅ are each phenyl, and A and B are —NF₁₂. The synthesis steps are as follows:
First, nitrogen gas was fed to a 100 ml three-necked flask for 30 minutes. 0.6106 g (1.25 mmol) of C, 0.2079 g (1.25 mmol) of terephthalic acid, 0.3 g of CaCl₂, 0.9 ml of TPP, 1.2 ml of pyridine, and 5 ml of NMP were added to the flask and stirred. The flask was heated to 100° C., the reaction was continued for 4 hours, and then the flask was cooled to room temperature. After the reaction, the polymer solution obtained was slowly poured into 300 ml of methanol and the product was precipitated. The resultant fibrous precipitate was filtered, and washed with methanol and hot water. The product was collected and dried at 150° C. to obtain 0.7568 g. Next, the synthesized polyetheramide polymer was dissolved in DMAc or NMP, so that the solid content of the solution was about 20%. The polyamide solution was coated onto a glass substrate by a coater and the film thickness was controlled at about 45 μm. The glass substrate was treated in a hot air circulating oven at 80° C. for 12 hours to remove most of the solvent, followed by further treatment at 200° C. for 2 hours. Finally, it was immersed in water to separate the C-PA thin film from the glass substrate. The glass transition temperature of the C-PA thin film measured by DSC was 266° C.

### Example 16

Synthesis of Compound C-PI

The phosphorus-containing polyimide C-PI is synthesized with the phosphorus-containing compound C, wherein Q is

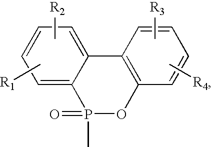

R₁-R₄ are each hydrogen, Ar¹, Ar², and R₅ are each phenyl, and A and B are —NH₂. The synthesis steps are as follows:
0.7328 g (1.5 mmol) of the diamine monomer C, 0.4653 g (1.5 mmol) of ODPA, and 7.8 g of m-cresol were weighed and mixed in a 100 ml three-necked flask. The reaction temperature was raised to 200° C. The reaction was continued for 2 hours, and the reactants were poured into methanol. Precipitate was formed and filtered. The resultant precipitate was washed with hot methanol for 24 hours. The precipitate was filtered and dried at 100° C. to obtain 1.1231 g of the product. The dried product was dissolved in DMF, so that the solid content of the solution was about 20%. The polyimide solution was coated onto a glass substrate by a coater and the film thickness was controlled at about 20 μm. The glass substrate was treated in a hot air circulating oven at 80° C. for 12 hours to remove most of the solvent followed by further treatment at 200° C. for 2 hours The glass transition temperature of the thin film was measured by DSC was 282° C.

The implementation of the present invention described above can be illustrated by Scheme 3 shown below.

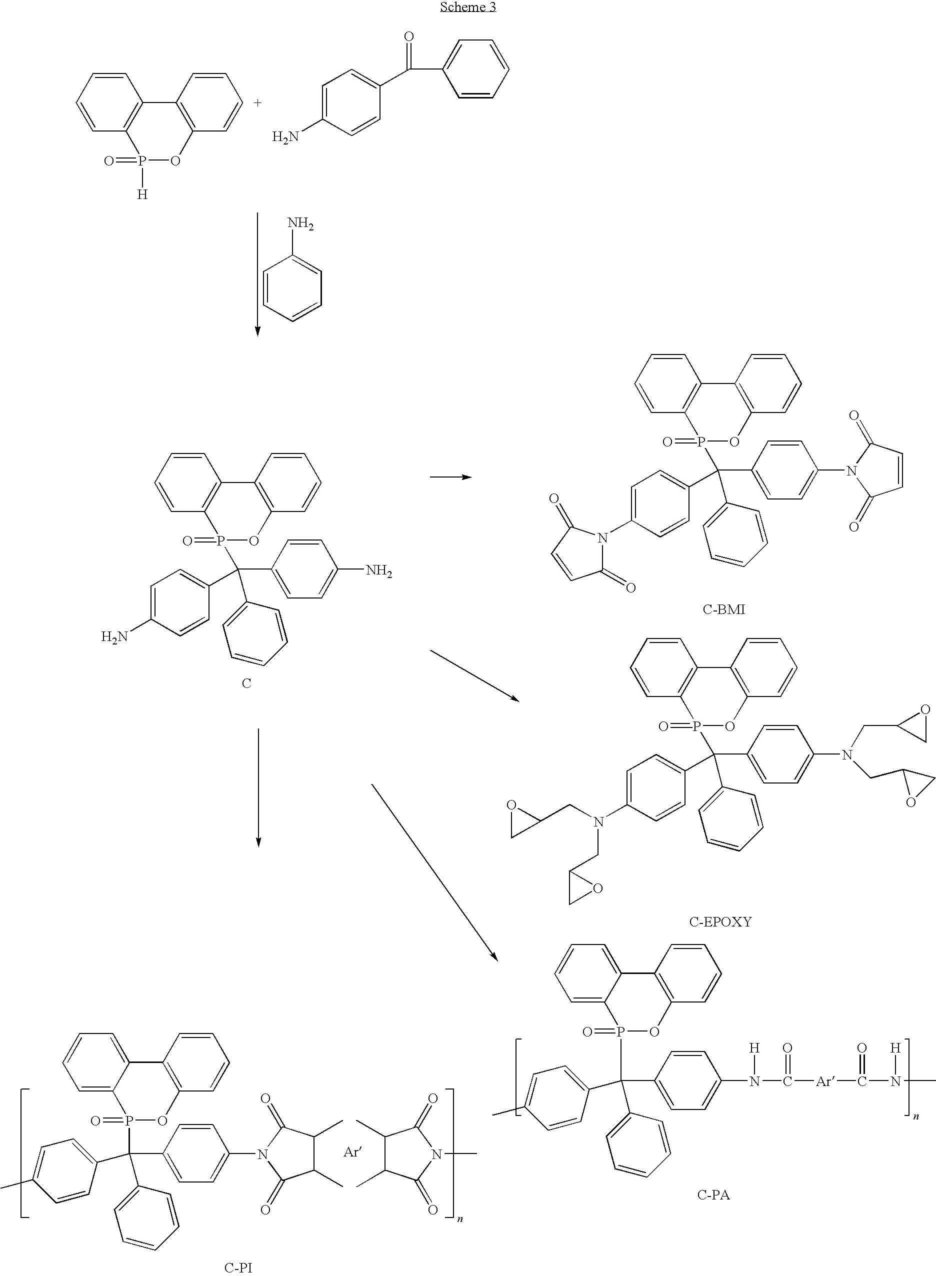

### Example 17

Synthesis of Compound D

The phosphorus-containing compound D, wherein Q is

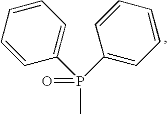

Ar¹ and Ar² are each phenyl, R₅ is methyl, and A and B are —NH₂, is synthesized with diphenylphosphine oxide, aniline, 4′-aminoacetophenone, and an acid catalyst. The synthesis steps are as follows:
10.11 g (0.05 mol) of an organophosphorus compound, diphenylphosphine oxide, 23.28 g (0.25 mol) of aniline, 6.76 g (0.05 mol) of 4′-aminoacetophenone, and 0.216 g (2 wt % of diphenylphosphine oxide) of p-toluenesulfonic acid were placed in a 250 ml three-necked reactor.

Next, the reaction temperature was raised to 80° C. The reaction was continued for 24 hours and the stirring was stopped. The reactor was cooled to room temperature. The product was dissolved with methanol, precipitated by adding water, filtered, and dried to obtain the product D. The yield is 75%, and the melting point is 143° C.

### Example 18

Synthesis of Compound D-BMI

The compound D-BMI is synthesized with the phosphorus-containing compound D, wherein Q is

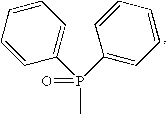

Ar¹ and Ar² are each phenyl, R₅ is methyl, and A and B are —NH₂. The synthesis steps are as follows:
20.62 g (0.05 mol) of D, 9.81 g (0.1 mol) of maleic anhydride, and 200 ml acetone were added to a 500 ml reactor. After 4 hours of reaction in an ice bath, 50 ml of acetic anhydride and 8.50 g of sodium acetate were added to the reactor. The temperature was raised to 60° C. and the reaction was continued for 4 hours. The solvent was distilled off under reduced pressure, and the product was precipitated with ethanol. The product was then recrystallized directly from ethanol to give the pure compound D-BMI.

### Example 19

Synthesis of Compound D-EPOXY

The compound D-EPOXY having epoxy group is synthesized with the phosphorus-containing compound D, wherein Q is

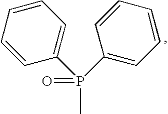

Ar¹ and Ar² are each phenyl, R₅ is methyl, and A and B are —NH₂. The synthesis steps are as follows:
103 g of D and 925 g of epichlorohydrin were added to a 3 L reactor and stirred to form a uniformly mixed solution under normal atmosphere. The reaction temperature was raised to 70° C. under an absolute pressure of 190 mmHg, and 200 g of 20% sodium hydroxide solution was added to the reactor in batches in 4 hours. At the same time, water in the reactor was removed by azeotropic distillation. After the reaction was completed, the epichlorohydrin and the solvent were completely distilled off under reduced pressure, and the product was dissolved with methyl ethyl ketone and deionized water. Sodium chloride in the resin was washed off with water, and the solvent was completely distilled off under reduced pressure to obtain light yellow epoxy group-containing D-EPOXY. The epoxy equivalent is 232.

### Example 20

Synthesis of Polymer D-PA

The phosphorus-containing polyamide D-PA is synthesized with the phosphorus-containing compound D, wherein Q is

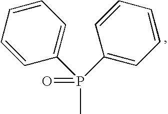

Ar¹ and Ar² are each phenyl, R₅ is methyl, and A and B are —NH₂. The synthesis steps are as follows:
First, nitrogen gas was fed to a 100 ml three-necked flask for 30 minutes. 0.5156 g (1.25 mmol) of D, 0.2079 g (1.25 mmol) of terephthalic acid, 0.3 g of calcium chloride (CaCl₂), 0.9 ml of TPP, 1.2 ml of pyridine, and 5 ml of NMP were added to the flask and stirred. The flask was heated to 100° C., the reaction was continued for 4 hours, and then the flask was cooled to room temperature. After the reaction, the polymer solution obtained was slowly poured into 300 ml of methanol and the precipitate was formed. The resultant fibrous precipitate was filtered, washed with methanol and hot water. The product was collected and dried at 150° C. to obtain 0.6973 g. Next, the synthesized polyetheramide polymer was dissolved in DMAc or NMP, so that the solid content of the solution was about 20%. The polyamide solution was coated onto a glass substrate by a coater and the film thickness was controlled at about 45 μm. The glass substrate was treated in a hot air circulating oven at 80° C. for 12 hours to remove most of the solvent, followed by further treatment at 200° C. for 2 hours. Finally, it was immersed in water to separate the D-PA thin film from the glass substrate. The glass transition temperature of the D-PA thin film measured by DSC was 268° C.

### Example 21

Synthesis of Polymer D-PI

The phosphorus-containing polyimide D-PI is synthesized with the phosphorus-containing compound D, wherein Q is

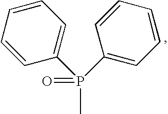

Ar¹ and Ar² are each phenyl, R₅ is methyl, and A and B are —NH₂. The synthesis steps are as follows:
0.6187 g (1.5 mmol) of the diamine monomer D, 0.4653 g (1.5 mmol) of ODPA, and 7.8 g of m-cresol were weighed and mixed in a 100 ml three-necked flask. The reaction temperature was raised to 200° C. The reaction was continued for 2 hours and the reactants were poured into methanol. Precipitate was formed and filtered. The resultant precipitate was washed with hot methanol for 24 hours. The precipitate was filtered and dried at 100° C. to obtain 0.9384 g of the product. The dried product was dissolved in DMF, so that the solid content of the solution was about 20%. The polyimide solution was coated onto a glass substrate by a coater and the film thickness was controlled at about 20 μm. The glass substrate was treated in a hot air circulating oven at 80° C. for 12 hours to remove most of the solvent, followed by further treatment at 200° C. for 2 hours. The glass transition temperature of the thin film measured by DSC was 268° C.

The implementation of the present invention described above can be illustrated by Scheme 4 shown below.

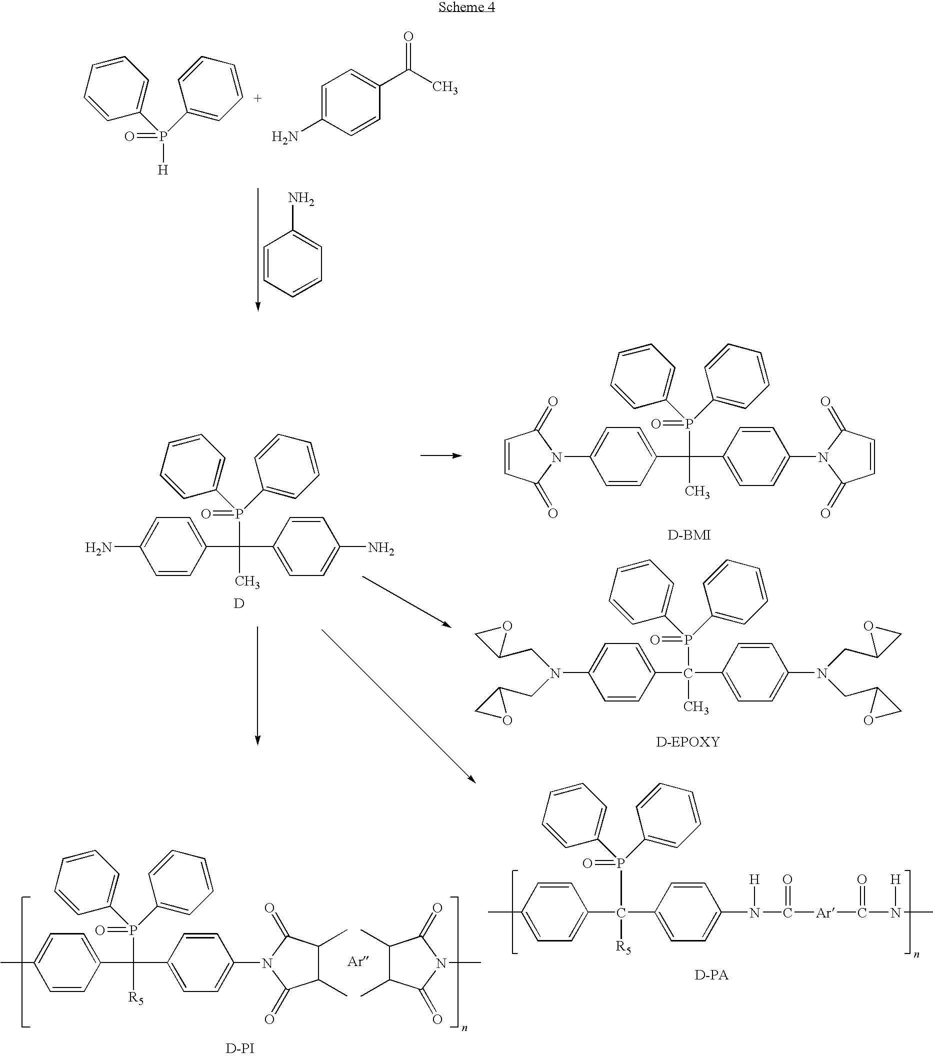

The following claims are used to define the reasonable scope of the present invention. It should be appreciated that any obvious modifications achieved by those skilled in the art on the basis of the disclosure of the present invention should also fall within the reasonable scope of the present invention.

We claim:

1. A phosphorus-containing compound of general formula (I) 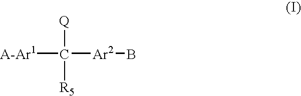
wherein
Q is 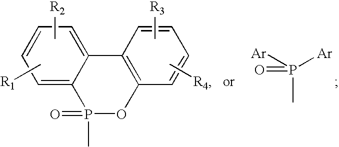
R₁-R₄ are independently selected from the group consisting of hydrogen, C₁-C₁₀ alkyl, C₁-C₁₀ alkoxy, C₁-C₁₀ halo-alkyl, C₃-C₁₀ cycloalkyl, —CF₃, —OCF₃, and halogen;
R₅ is selected from the group consisting of hydrogen, C₁-C₁₀ alkyl, C₁-C₁₀ alkoxy, C₁-C₁₀ halo-alkyl, C₃-C₁₀ cycloalkyl, —CF₃, —OCF₃, halogen, and —Ar³;
Ar is 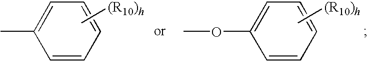
Ar¹ and Ar² are each independently selected from the group consisting of: 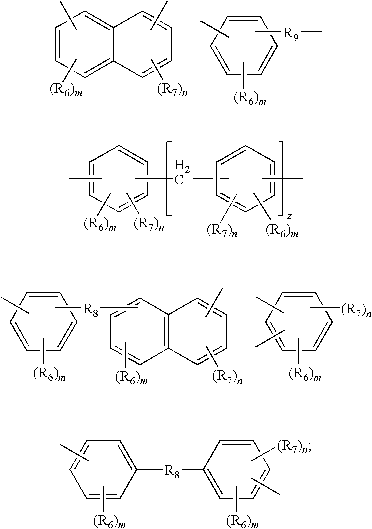
Ar³ is selected from the group consisting of: 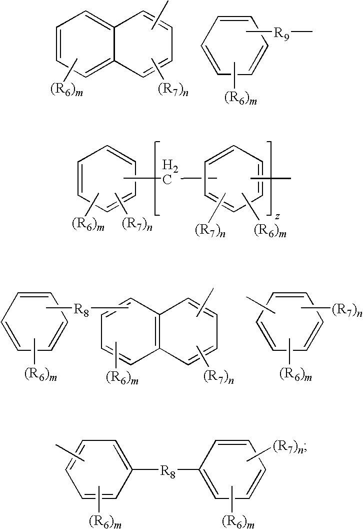
R₆ is selected from the group consisting of hydrogen, C₁-C₁₀ alkyl, C₁-C₁₀ alkoxy, C₁-C₁₀ halo-alkyl, C₃-C₁₀ cycloalkyl, —CF₃, —OCF₃, and halogen;
R₇ is selected from the group consisting of —OH, —NH₂, —NO₂, —SH, —COOH, —SO₃H, —COH, —NHCOCH₃, and —OCH₃;
R₈ is selected from the group consisting of —CR₂—, —(CH₃)₂CH₂—, —CO—, —SO₂—, —O—, and —NH—, or is absent;
R₉ is —(CH₂)ₚ—, or is absent;
R₁₀ is C₁-C₄ alkyl or C₆-C₁₈ aryl;
m and n are each an integer of 0-4; z and p are each an integer of 1-20; and h is an integer of 0-5; and
A and B are each independently selected from the group consisting of —NO₂,

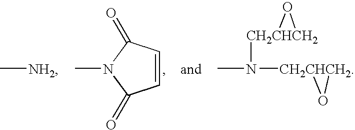

2. The compound of formula (I) according to claim 1, wherein Q is 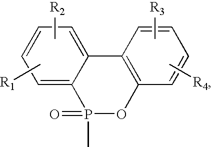
R₁-R₄ are each hydrogen, Ar¹ and Ar² are each phenyl, and R₅ is hydrogen,
(a) when A is —N₂O and B is —NH₂, the compound of formula (I) is of formula (A′); or 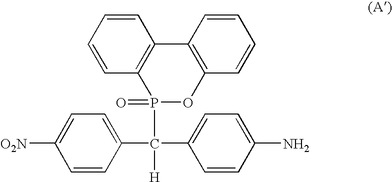
(b) when A and B are —NH₂, the compound of formula (I) is of formula (A); or 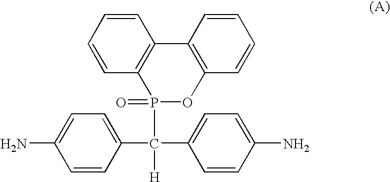
(c) when A and B are 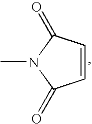
the compound of formula (I) is of formula (A-BMI); or 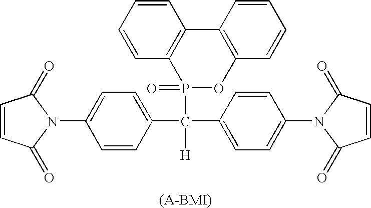
(d) when A and B are 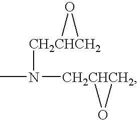
the compound of formula (I) is of formula (A-EPOXY)

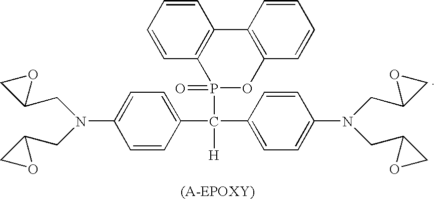

3. The compound of formula (I) according to claim 1, wherein Q is 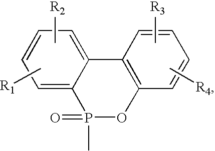
R₁-R₄ are each hydrogen, Ar¹ and Ar² are each phenyl, and R₅ is methyl,
(a) when A and B are —NH₂, the compound of formula (I) is of formula (B); or 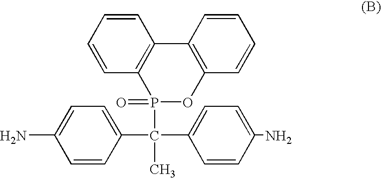
(b) when A and B are 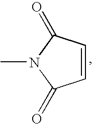
the compound of formula (I) is of formula (B-BMI); or 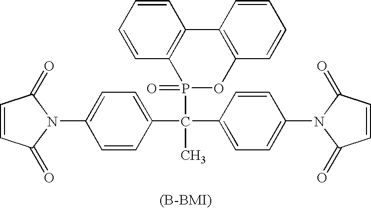
(c) when A and B are 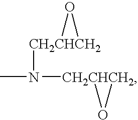
the compound of formula (I) is of formula (B-EPOXY)

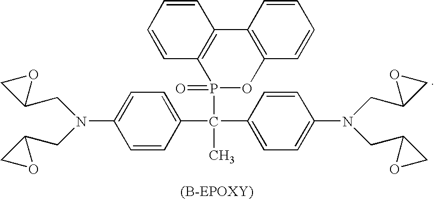

4. The compound of formula (I) according to claim 1, wherein Q is 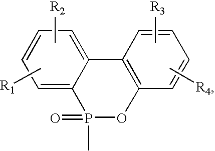
R₁-R₄ are each hydrogen, Ar¹ and Ar² are each phenyl, and R₅ is phenyl,
(a) when A and B are —NH₂, the compound of formula (I) is of formula (C); or 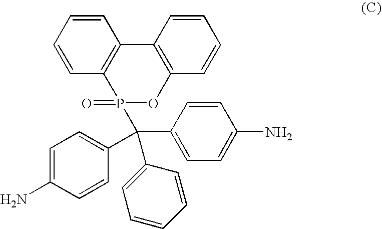
(b) when A and B are 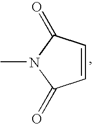
the compound of formula (I) is of formula (C-BMI); or 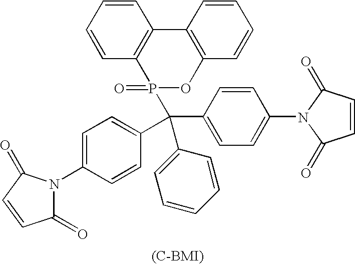
(c) when A and B are 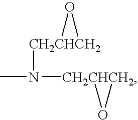
the compound of formula (I) is of formula (C-EPOXY)

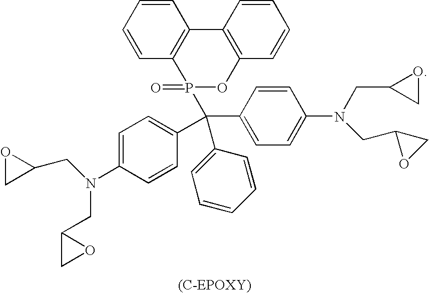

5. The compound of formula (I) according to claim 1, wherein Q is 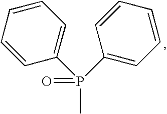
Ar¹ and Ar² are each phenyl, and R₅ is methyl,
(a) when A and B are —NH₂, the compound of formula (I) is of formula (D); or 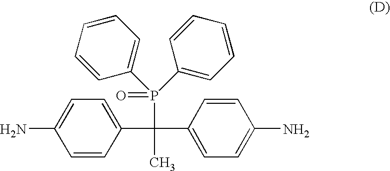
(b) when A and B are 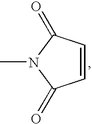
the compound of formula (I) is of formula (D-BMI); or 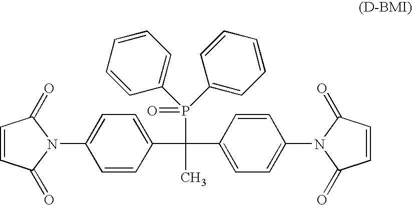
(c) when A and B are 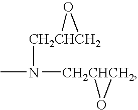
the compound of formula (I) is of formula (D-EPOXY)

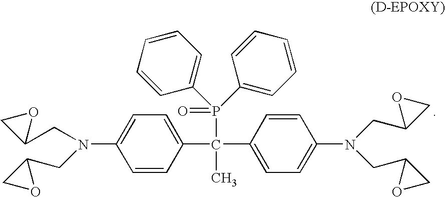

6. A process of preparing the compound of formula (I) according to claim 1, comprising reacting an organophosphorous compound of formula (II) and a compound of formula (III) with a compound of formula (IV) in the presence of an acid catalyst to form the compound of formula (I), 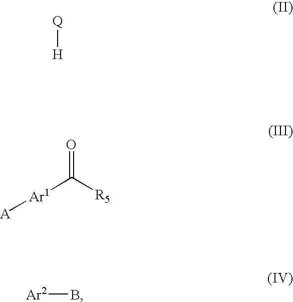
wherein Q, Ar¹, Ar², A, B, and R₅ are as defined in claim 1.

7. The process according to claim 6, wherein Q is 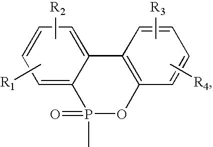
R₁-R₄ are hydrogen, and Ar¹ and Ar² are phenyl, the process comprising
(a) when A is —N₂O, B is —NH₂, and R₅ is hydrogen,
(i) reacting 9,10-dihydro-9-oxa-10-phosphaphenanthrene-10-oxide (DOPO) of formula (II) with the compound of formula (III);
(ii) adding the compound of formula (IV) and the acid catalyst to form the compound of formula (A′);
(iii) hydrogenating the compound of formula (A′) in a solvent to form the product, the compound of formula (A);
(b) when A and B are —NH₂, and R₅ is methyl or phenyl,
(i) reacting the 9,10-dihydro-9-oxa-10-phosphaphenanthrene-10-oxide (DOPO) of formula (II) and the compound of formula (III) with the compound of formula (IV) in the presence of the acid catalyst to form the compound of formula (B) or formula (C).

8. The process according to claim 6, wherein Q is 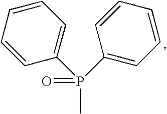
Ar¹ and Ar² are each phenyl, A and B are —NH₂, and R₅ is methyl, the process comprising: reacting the diphenylphosphine oxide of formula (II) and the compound of formula (III) with the compound of formula (IV) in the presence of the acid catalyst to form the compound of formula (D).

9. The process according to claim 6, wherein the acid catalyst is selected from the group consisting of protic acids or Lewis acids.

10. The process according to claim 6, wherein the acid catalyst is selected from the group consisting of acetic acid, p-toluenesulfonic acid, methanesulfonic acid, calmagite, sulfuric acid, orthanilic acid, 3-pyridinesulfonic acid, sulfanilic acid, hydrogen chloride (HCl), hydrogen bromide (HBr), hydrogen iodide (HI), hydrogen fluoride (HF), trifluoroacetic acid (CF₃COOH), nitric acid (HNO₃), phosphoric acid (H₃PO₄), aluminum chloride (AlCl₃), boron fluoride (BF₃), ferric bromide (FeBr₃), ferric chloride (FeCl₃), boron chloride (BCl₃), and titanium chloride (TiCl₄).

11. The process according to claim 6, wherein the amount of the acid catalyst used is 0.1 wt %-30 wt % of the amount of the organophosphorous compound.

12. The process according to claim 7, wherein the solvent is DMF.

13. A phosphorus-containing polyamide of general formula (PA), 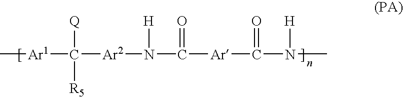
wherein
Q, Ar¹, Ar², and R₅ are as defined in claim 1, Ar¹ is selected from the group consisting of 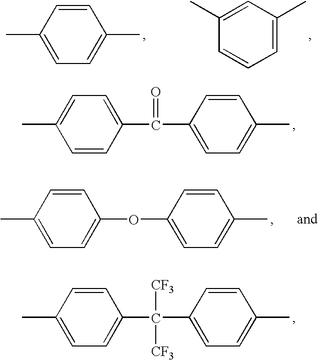
and n is an integer of 30-300.

14. The phosphorus-containing polyamide of formula (PA) according to claim 13, wherein Q is 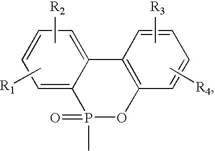
R₁-R₄ are hydrogen, and Ar¹, Ar², and Ar′ are each phenyl,
(a) when R₅ is hydrogen, the phosphorus-containing polyamide of formula (PA) is of formula (A-PA); or 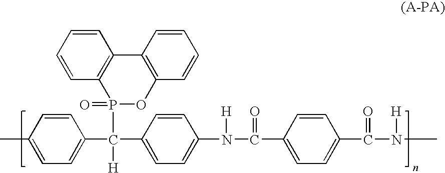
(b) when R₅ is methyl, the phosphorus-containing polyamide of formula (PA) is of formula (B-PA); or 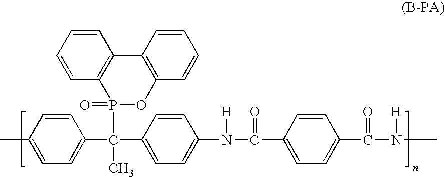
(c) when R₅ is phenyl, the phosphorus-containing polyamide of formula (PA) is of formula (C-PA)

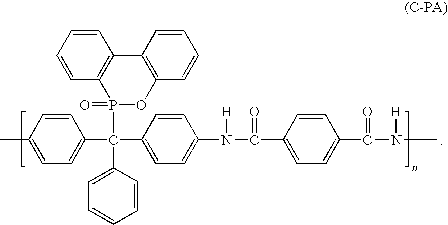

15. The phosphorus-containing polyamide of formula (PA) according to claim 13, wherein when Q is 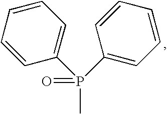
Ar¹, Ar², and Ar′ are each phenyl, and R₅ is inethyl, the phosphorus-containing polyamide of formula (PA) is of formula (D-PA),

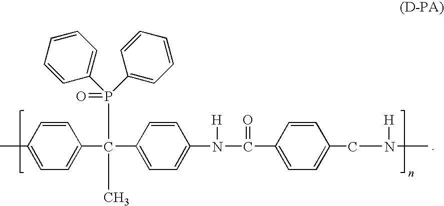

16. A process of preparing a phosphorus-containing polyamide of formula (PA), 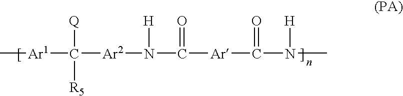
comprising reacting the compound of formula (I) with a diacid compound of formula (V) in a solvent to form the phosphorus-containing polyamide of formula (PA), 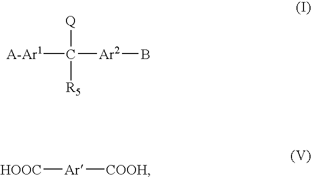
wherein
Q, Ar¹, Ar², A, B, and R₅ are as defined in claim 1, Ar′ is selected from the group consisting of 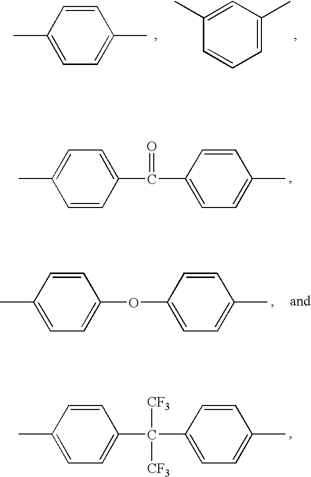
and n is an integer of 30-300.

17. The process according to claim 16, wherein the solvent is N-methylpyrrolidone (NMP).

18. The process according to claim 16, wherein calcium chloride is used in the process.

19. The process according to claim 16, wherein triphenyl phosphite (TPP) is used in the process.

20. The process according to claim 16, wherein pyridine is used in the process.

21. A phosphorus-containing polyimide of general formula (PI), 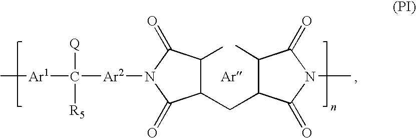
wherein
Q, Ar¹, Ar², and R₅ are as defined in claim 1, Ar″ is selected from the group consisting of 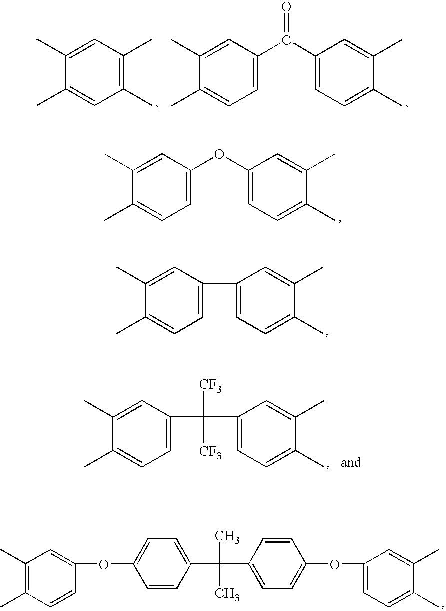
and n is an integer of 30-300.

22. The phosphorus-containing polyimide of formula (PI) according to claim 21, wherein Q is 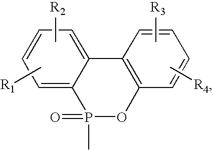
R₁-R₄ are hydrogen, Ar¹ and Ar² are each phenyl, and Ar″ is 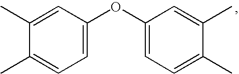
(a) when R₅ is hydrogen, the compound of formula (PI) is of formula (A-PI); or 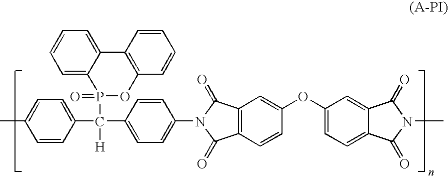
(b) when R₅ is methyl, the compound of formula (PI) is of formula (B-PI); or 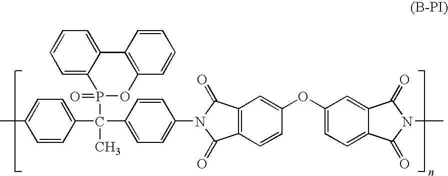
(c) when R₅ is phenyl, the compound of formula (PI) is of formula (C-PI),

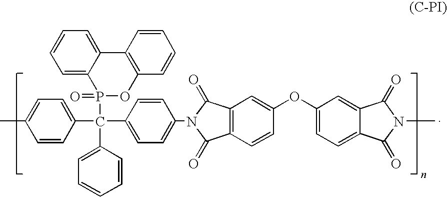

23. The phosphorus-containing polyimide of formula (PI) according to claim 21, wherein Q is 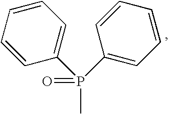
Ar¹ and Ar² are each phenyl, and Ar″ is 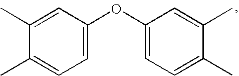
and when R₅ is hydrogen, the compound of formula (PI) is of formula (D)-PI),

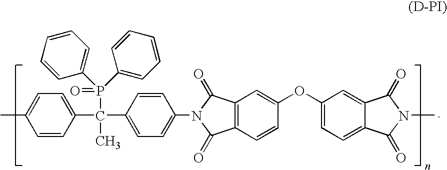

24. A process of preparing a phosphorus-containing polyimide of formula (PI), 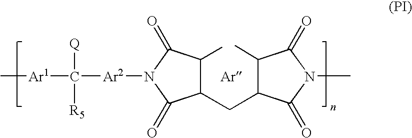
comprising reacting the compound of formula (I) with the dianhydride compound of formula (VI) in a solvent to form the phosphorus-containing polyimide of formula (PI), 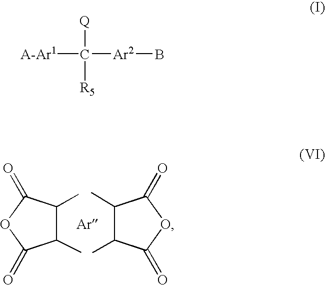
wherein, Q, Ar¹, Ar², A, B, and R₅ are as defined in claim 1, Ar″ is selected from the group consisting of 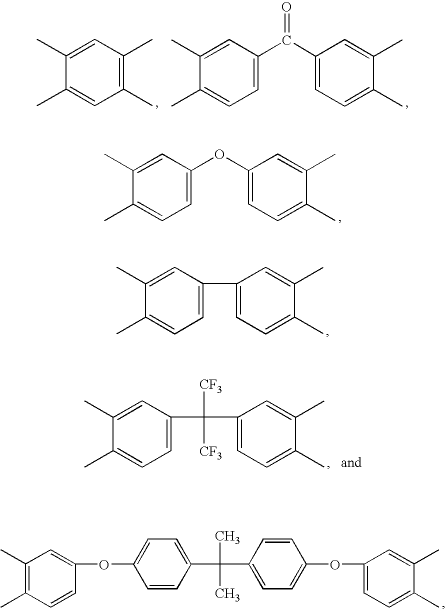
and n is an integer of 30-300.

25. The process according to claim 24, wherein the solvent is m-cresol.
